(19) United States
(12) Patent Application Publication
(10) Pub. No.: US 2021/0351394 A1
(43) Pub. Date: Nov. 11, 2021

(54) POROUS NI ELECTRODES AND A METHOD OF FABRICATION THEREOF

(71) Applicants: INSTITUT NATIONAL DE LA RECHERCHE SCIENTIFIQUE, Montreal (CA); THE GOVERNING COUNCIL OF THE UNIVERSITY OF TORONTO, Toronto (CA)

(72) Inventors: Daniel GUAY, St-Lambert (CA); Julie GAUDET, La Prairie (CA); Minghui HAO, Longueuil (CA); Valerie CHARBONNEAU, Sainte-Therese (CA); Sebastien GARBARINO, Montreal (CA); Steven J. Thorpe, Picton (CA); Pedro Henrique ALVES SOBRINHO, Toronto (CA)

(21) Appl. No.: 16/870,886

(22) Filed: May 8, 2020

(51) Int. Cl. H01M 4/04; H01M 4/32; H01M 4/525

(52) U.S. Cl. CPC H01M 4/045; H01M 4/525; H01M 4/32; H01M 4/0471

(57) ABSTRACT

A method of fabrication of Ni electrodes by hydrogen bubbles dynamic templated electrodeposition of Ni on a substrate, the method comprising one of: i) selecting a current, and selecting an electrodeposition time at the selected current according to a deposit target thickness on the substrate; and ii) selecting an electrodeposition time, and selecting a current during the selected electrodeposition time according to the deposit target thickness on the substrate. The dynamic hydrogen bubble templated Ni films comprises micrometer-sized pores at a surface thereof, and pore walls having a cauliflower-like secondary structure.

### FIELD OF THE INVENTION

The present invention relates to Ni electrodes. More specifically, the present disclosure is concerned with porous Ni electrodes and a method of fabrication thereof.

### BACKGROUND OF THE INVENTION

Electrochemical water splitting is a promising approach to provide clean and storable chemical fuels (H₂). When connected to renewable energy sources whose production is intermittent, water electrolyzers can play a fundamental role in the development of a sustainable energy network. Several approaches to water splitting catalytic processes, such as microbial, photo and photo-electro for example, still present sluggish oxygen evolution reaction (OER) kinetics that limits the overall efficiency of the process. Among materials exhibiting good activity and stability for the OER, oxide compounds are the most active, notably binary noble metal oxides (Ru, Ir) and those having complex structures (perovskite, spinel, layered) [1-5]. In strongly alkaline media (pH ≥13), Ni metallic alloys are materials of sustained activity [6].

In combination with improving the intrinsic catalytic properties of OER catalysts, micro-structuring of the electrode surface is used to increase the number and surface density of reactive sites having good electronic connectivity to the underlying substrate and easy access to the electrolyte, and nano-engineering of the electrode surface is used facilitate the escape of gas bubbles, in view of applications and device operation in practical electrolysis conditions (j≥100 mA cm⁻²). Indeed, the release of O₂ bubbles at large current density is known to alter the reaction efficiency due to overpotentials associated with greater bubble resistance [7]. The mechanisms responsible for this increased inefficiency include O₂ bubble formation leading to a net decrease of the available underlying catalytic Ni sites; O₂ bubbles coalescing near the Ni surface which may also cause large ohmic losses due to the formation of non-conductive gas layers; and pH modification (increase) which may lead to possible instability of the catalyst's corrosion processes. In this context, it is of utmost importance to facilitate the release of gas bubbles from the surface of electrodes participating in gas evolving reactions like oxygen evolution.

The size, size distribution, adsorption, and residency time of gas bubbles on the electrodes can be varied through ultra-gravity and ultrasonic treatment [8, 9, 10, 11], leading to decreased overpotentials and increased current density. However, these methods are difficult to implement in industrial production and not cost-effective for commercial systems. More recently, it was reported that passive control of the bubble behavior can be accomplished through nano-engineering of the electrode surface to impart intrinsically active materials with carefully tailored porosity that facilitate the detachment of oxygen bubbles from the surface and, in turn, improved the extrinsic (overall) performances of electrodes. These electrodes are termed “superaerophobic” as gas bubbles trapped at their surfaces typically exhibit very large contact angles [12]. In the literature, several oxides and hydroxides containing various amounts of Ni, Co, Fe and Zn superaerophobic electrodes with nano-engineered surface have shown improved OER characteristic [13-17]. This improvement of the extrinsic properties of electrodes for gas evolving reactions through nano-engineering of the electrode surface is not restricted to the OER and was also observed for other reactions, such as hydrogen evolution [18-20]. Indeed, the ability to fabricate materials and electrodes with optimized porosity has reignited interest in research areas involving Li batteries, capacitors, sensors, and catalysis [21-24]. However, in most of these studies, the materials investigated and the methods used to impart the necessary nano-engineered characteristics to the electrode surface may not be relevant to industrial applications and commercial devices.

There is still a need in the art for Ni electrodes and a method of fabrication thereof.

The present description refers to a number of documents, the content of which is herein incorporated by reference in their entirety.

### SUMMARY OF THE INVENTION

More specifically, in accordance with the present invention, there is provided a method of fabrication of Ni electrodes by hydrogen bubbles dynamic templated electrodeposition of Ni on a substrate, the method comprising one of: i) selecting a current, and selecting an electrodeposition time at the selected current according to a deposit target thickness on the substrate; and ii) selecting an electrodeposition time, and selecting a current during the selected electrodeposition time according to the deposit target thickness on the substrate.

Hydrogen bubbles dynamic templated Ni film, comprising micrometer-sized pores at a surface thereof, and pore walls having a cauliflower-like secondary structure.

Hydrogen bubbles dynamic templated Ni electrode having a ratio between anodic (Qₐ) and cathodic (Q_{c}) coulombic charge of redox transition of a mean value of 1.00±0.13, and Qₐ values in a range between 62±4 mC cm⁻² and 539±57 mC cm⁻².

Dynamic hydrogen bubble templated Ni films, comprising a microporous primary structure and a highly porous cauliflower-like secondary structure.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1A is a cross section of Ni_{DHBT}, with deposition conditions are of −2 A cm⁻² in 0.1 M NiCl₂-6H₂O+2 MNH₄Cl, electrodeposition time of 50 s;

FIG. 1B is a cross section of Ni_{DHBT}, with deposition conditions are of −2 A cm⁻² in 0.1 M NiCl₂-6H₂O+2 MNH₄Cl, electrodeposition time of 100 s;

FIG. 1C is a cross section of Ni_{DHBT}, with deposition conditions are of −2 A cm⁻² in 0.1 M NiCl₂-6H₂O+2 MNH₄Cl, electrodeposition time of 250 s;

FIG. 1D is a cross section of Ni_{DHBT}, with deposition conditions are of −2 A cm⁻² in 0.1 M NiCl₂-6H₂O+2 MNH₄Cl, electrodeposition time of 450 s;

FIG. 1E is a top view of FIG. 1A;

FIG. 1F is a top view of FIG. 1B;

FIG. 1G is a top view of FIG. 1C

FIG. 1H is a top view of FIG. 1D;

FIG. 2A is a contact angle image for a 5 μL air bubble and a 5 μL water droplet (E-H) on a Ni plate;

FIG. 2B is a contact angle image for a 5 μL air bubble and a 5 μL water droplet (E-H) on a Ni_{DHBT} film with Electrodeposition times (Td)=50 s;

FIG. 2C is a contact angle image for a 5 μL air bubble and a 5 μL water droplet (E-H) on a Ni_{DHBT} film with Electrodeposition times (Td)=250 s;

FIG. 2D is a contact angle image for a 5 μL air bubble and a 5 μL water droplet (E-H) on a Ni_{DHBT} film with Electrodeposition times (Td)=450 s;

FIG. 2E is a contact angle image for a 5 μL air bubble and a 5 μL water droplet (E-H) on a Ni plate;

FIG. 2F is a contact angle image for a 5 μL air bubble and a 5 μL water droplet (E-H) on a Ni_{DHBT} film with Electrodeposition times (Td)=50 s;

FIG. 2G is a contact angle image for a 5 μL air bubble and a 5 μL water droplet (E-H) on a Ni_{DHBT} film with Electrodeposition times (Td)=250 s;

FIG. 2H is a contact angle image for a 5 μL air bubble and a 5 μL water droplet (E-H) on a Ni_{DHBT} film with Electrodeposition times (Td)=450 s);

FIG. 3 shows cyclic voltammograms (5 mV s⁻¹) in 1 M KOH for Ni electrodes obtained by the dynamic hydrogen bubble template electrodeposition method; the electrodeposition time is shown for each electrode;

FIG. 4A shows chronopotentiometric curves at +250 mA cm⁻² in 1 M KOH for Ni_{DHBT} electrodes prepared at different electrodeposition times;

FIG. 4B shows potential values recorded at t=900 s corresponding to FIG. 4A; the error bars were obtained from three independent measurements performed on a set of three electrodes prepared in the same conditions (three replicates, see FIG. 20); the open symbols (0) are for Ni_{DHBT} electrodes measured in 1 M KOH spiked with 10 ppm of Fe impurities;

FIG. 5A shows the effect of the presence of FeCl₂ (10 ppm) on the CVs of Ni_{DHBT} film;

FIG. 5B shows chronopotentiometric curves recorded at +250 mA cm⁻² in 1 M KOH spiked with FeCl₂ (10 ppm);

FIG. 5C shows the variation of the iR-corrected overpotential vs the logarithm of the steady-state current density, j; the electrolyte was 1 M KOH spiked with 10 ppm FeCl₂; the Tafel slopes are 31 and 29 mV/dec for Ni plate and Ni_{DHBT} film, respectively;

FIG. 6A shows raw data without normalization for the geometric surface area (0.4 cm²) of the substrate in experiments of optimization of Ni dynamic templated electrodeposition (DBTH) on pressed Ni foam;

FIG. 6B shows raw data without normalization for the geometric surface area (0.4 cm²) of the substrate in experiments of optimization of Ni dynamic templated electrodeposition (DBTH) on pressed Ni foam;

FIG. 6C shows raw data without normalization for the geometric surface area (0.4 cm²) of the substrate in experiments of optimization of Ni dynamic templated electrodeposition (DBTH) on pressed Ni foam;

FIG. 7A shows a comparison with Ni dynamic templated electrodeposition (DBTH on a Ni plate;

FIG. 7B shows a comparison with Ni dynamic templated electrodeposition (DBTH on a Ni plate;

FIG. 7C shows a comparison with Ni dynamic templated electrodeposition (DBTH on a Ni plate;

FIG. 8A shows the front side, facing the counter electrode;

FIG. 8B shows the back side, not facing the counter electrode;

FIG. 9A shows SEM photos of A-Ni foam;

FIG. 9B shows SEM photos of Ni Foam+DHBT (600 s)′;

FIG. 9C shows SEM photos of Ni DHBT (450 s) on Ni plate;

FIG. 10A shows Ni dynamic templated electrodeposition (DBTH on Ni Foam, with and without Fe;

FIG. 10B shows Ni dynamic templated electrodeposition (DBTH on Ni Foam, with and without Fe;

FIG. 11A shows short-term chronoamperometric curves of Ni dynamic templated electrodeposition (DBTH) on Ni foam electrodes at 10 and 250 mA cm⁻² in 1 M KOH at 22 C with and without 10 ppm FeCl₂;

FIG. 11B shows uncompensated resistance with and without 10 ppm FeCl₂;

FIG. 11C shows overpotential with and without 10 ppm FeCl₂;

FIG. 12A shows SEM micrographs of Ni dynamic templated electrodeposited (DBTH) on an Ni VECO sample;

FIG. 12B shows SEM micrographs of Ni dynamic templated electrodeposited (DBTH) on an Ni VECO sample;

FIG. 12C shows SEM micrographs of Ni dynamic templated electrodeposited (DBTH) on an Ni VECO sample;

FIG. 13A compares Ni VECO electrodes with and without Ni DHBT tested in 1 M KOK with 10 ppm FeCl₂;

FIG. 13B compares Ni VECO electrodes with and without Ni DHBT tested in 1 M KOK with 10 ppm FeCl₂;

FIG. 13C compares Ni VECO electrodes with and without Ni DHBT tested in 1 M KOK with 10 ppm FeCl₂;

FIG. 14 show Ni VECO electrode with and without Ni DHBT: FIG. 14A shows OER activity; FIG. 14B shows uncompensated resistance; and FIG. 14C shows overpotential at 10 and 250 mA cm⁻²;

FIG. 15 shows effect of deposition times on the mass of Ni coatings on a 1 cm² Ni plate substrate;

FIG. 16 show a fractal analysis of Ni_{DHBT} film: FIG. 16A shows the original SEM cross-section image of a Ni_{DHBT} film (Electrodeposition times (Td)=450 s) at ×500 magnification; FIG. 16B shows the contour image extracted from FIG. 16A; FIG. 16C shows ln plot of box count N vs box size r; FIG. 16D shows the derivative plot of ln(N) vs ln(r);

FIG. 17 shows the effect of deposition times on the coulombic charge, Qₐ, of the redox transition observed at ca 1.41 V, obtained from CV profiles recorded at 50 mV s−1 in 1 M KOH; the y-axis on the right-hand side displays the ratio between Qₐ and the mass of the deposits;

FIG. 18 show SEM micrographs: FIG. 18A: of Ni foam (1 mm thick) and FIG. 18B: of Ni_{DHBT} film;

FIG. 19 shows normalized current density vs electrode potential curves obtained following normalization of the CVs shown in FIG. 2 by the corresponding Qₐ values; the unit of the y-axis is s−1 and the area under the Ni(OH)₂/Ni(OOH) redox transition has unit of V s−1; upon division by the scan rate (5 mV s⁻¹), the area under each Ni(OH)₂/Ni(OOH) redox transition is dimensionless and has a value of 1;

FIG. 20 shows chronopotentiometric curves at +250 mA cm⁻² in 1 M KOH for different Ni plates and NiDHBT electrodes: FIG. 20A shows Ni plates, FIG. 202B shows NiDHBT with electrodeposition times (Td)=250 s, and FIG. 20C shows NiDHBT with electrodeposition times (Td)=450 s; error bars shown in FIG. 3B were obtained from these measurements;

FIG. 21 shows variation of the iRs-corrected electrode potential reached after 15 minutes of electrolysis at +250 mA cm⁻² with respect to the coulombic charge of the Ni(OH)₂/NiOOH transition Qₐ;

FIG. 22 show SEM images for Ni_{DHBT} films with electrodeposition times (Td)ep=450 s prior to (FIGS. 22A, 22B and 22C) and after (FIGS. 22D,22 E and 22F) polarization at 250 mA cm⁻² for 15 min in 1M KOH; indicating no morphological change due to strong O₂ gas evolution; and

FIG. 23 shows CVs of NiDHBT films with electrodeposition times (Td)=450 s recorded before and after the data of FIG. 5C were taken; the electrolyte being 1M KOH spiked with 10 ppm FeCl₂ and CV profiles recorded at 5 mV s−1; the charge under the redox peaks centered at ca 1.39 V is hardly changed, although the shape of the oxidation and reduction peaks are slightly modified.

### DESCRIPTION OF ILLUSTRATIVE EMBODIMENTS

The present invention is illustrated in further details by the following non-limiting examples.

A method for fabricating porous Ni electrodes, and Ni electrodes fabricated therewith are described. The method generally comprises using electrodeposition. Oxygen evolution reaction (OER) current densities are controlled, in particular within typical practical electrolysis conditions of j≥100 mA cm⁻², at reduced overpotential. The Ni porous electrodes have high surface area values.

According to an embodiment of an aspect of the present disclosure, a method for fabricating polycrystalline Ni electrodes generally comprises hydrogen bubbles dynamic templated electrodeposition (DHBT) of Ni alloy onto a substrate. The method comprises controlling the morphological features of the deposit to facilitate the release of oxygen bubbles during the oxygen evolution reaction (OER). During the cathodic Ni deposition, the method comprises selecting a large cathodic potential so that hydrogen bubbles are concomitantly evolved, thereby controlling a nano-engineered electrode surface with an open porosity that reaches the underlying substrate. The method is scaled up and the deposits are adherent, superaerophobic and mechanically stable under vigorous oxygen evolving conditions, and characterized by specific OER properties as illustrated hereinbelow.

In experiments, galvanostatic deposition (2 A cm²) from an aqueous solution of 0.1 M NiCl₂.6H₂O (ACROS Organics, ACS Reagent) and 2 MNH₄Cl(Fisher Chemical, Trace Metal Grade) was used to form fractal Ni foams having honeycomb-like primary and cauliflower-like secondary structures. These electrodes were denoted as Ni_{DHBT} (Dynamic Hydrogen Bubble Template) since both Ni deposition and H₂ evolution occur simultaneously. In all cases, commercial Ni plates (Alfa Aesar, Puratronic 99.9945% (metal basis)) were used as substrates. The films were deposited on one face of 1 cm×1 cm Ni substrates. The electrodes were then sealed in bent glass tubes so that the electrode surface was maintained in a vertical position and the Ni substrate uncovered face was not exposed to the electrolyte. In all cases, the exposed surface area was 1 cm². A saturated calomel electrode (SCE) and Pt gauze (Alfa Aesar, 99.9%) were used as a reference and counter electrodes, respectively. For the sake of clarity, all electrode potential values were converted to Reversible Hydrogen Electrode (RHE) scale. The distance between the counter and the working electrodes was fixed at about 5 mm. Ni electrodeposition was carried out using a Solartron 1480 A multipotentiostat for durations (electrodeposition times (Td)) up to 550 seconds. The faradaic efficiency for the Ni electroplating was about 27±8%, independently of the deposition duration. Following electroplating, the porous Ni electrodeposits were rinsed with water and dried under an Ar stream.

The surface morphologies of the obtained porous Ni films were characterized by scanning electron microscopy (SEM) (JEOL, JSM-6300F) and thicknesses were measured by SEM cross-section analysis. Energy dispersive X-ray (EDX, VEGA3 TESCAN) measurements were performed to determine the Fe content. Contact angle measurements were performed as following. Images of water droplets and (captive) air bubbles in contact with the electrode surface were captured by a Panasonic CCD camera (model GP-MF552). The volumes of the water droplets and air bubbles were 5 μL in both cases. Contact angles were determined using image processing program ImageJ software with the Dropsnake plugin.

Electrochemical characterization in Ar-saturated (Air Liquid, 99.999%) 1 M KOH (Fisher Chemical, ACS Reagent grade) was conducted in a conventional three-electrode system, using a Pt gauze and a saturated calomel electrode as auxiliary and reference electrodes, respectively. The working electrode and the counter electrode were not separated by a membrane. The solution (70 ml) was agitated by Ar bubbling. The distance between the working and the counter electrodes was 5 mm. Following a period of 10 minutes under open circuit potential (OCP) conditions, cyclic voltammograms (CV) (50 mV s−1) with different potential windows (0.5V to 1.4 V, 0.5 V to 1.6 V, and 0.5 V to 1.9 V) were performed until steady-state potentiodynamic features were obtained.

The last CV was recorded at 5 mV s−1. Galvanostatic oxidation was carried out at 10 mA cm⁻² for 15 min and then at 250 mA cm⁻² for 15 min, followed by a last CV (0.5V to 1.9 V, 5 mV s⁻¹). This sequence was applied to every Ni electrodes in order to ensure full conversion of nickel to β-Ni(OH)₂. The ohmic drop was measured by Electrochemical Impedance Spectroscopy (EIS) and an ohmic drop correction was manually applied to all potential values mentioned hereinbelow.

In a number of cases, CVs and polarization curves were recorded in 1 M KOH electrolyte spiked with Fe, and the concentration of Fe was varied between 0 and 10 ppm through the addition of FeCl₂.6H₂O (Alfa Aesar, 98%).

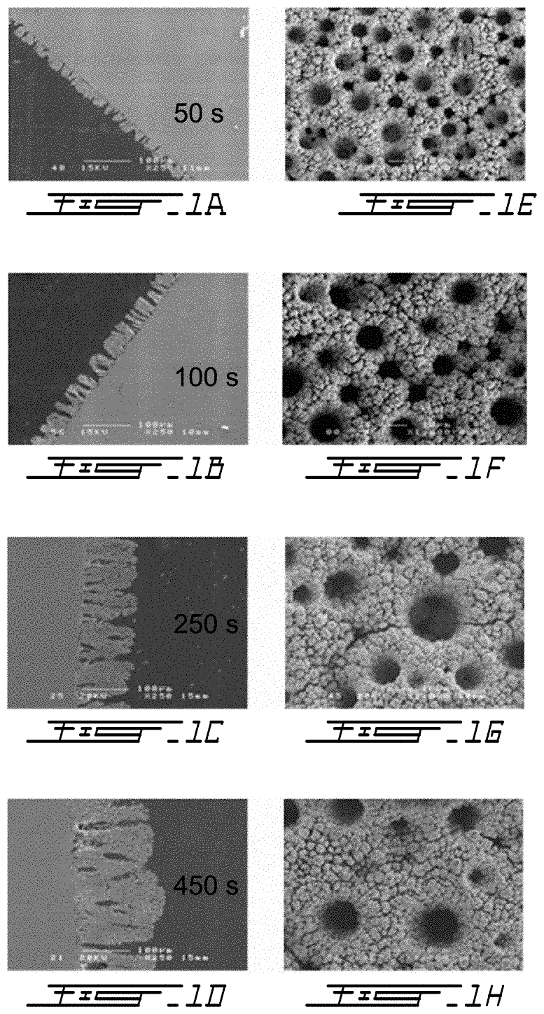

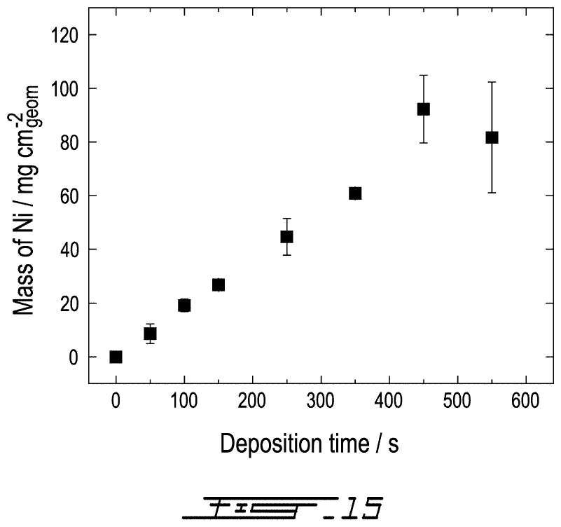

The morphological features of as-deposited Ni_{DHBT} films are shown in FIG. 1. All electrodeposition parameters remained the same (−2 A cm⁻² in 0.1 M NiCl₂-6H₂O+2 MNH₄Cl) except for the electrodeposition times (Td). As seen in FIGS. 1A to 1D, increasing the electrodeposition times (Td) led to a gradual increase of the Ni film thicknesses, from about 35 μm for (Td)=50 s up to 220 μm for (Td)=450 s. The deposited mass of Ni increased linearly with the electrodeposition times (Td), up to 100 mg cm⁻² for (Td)=450 s (see FIG. 15). The porosity of the films, calculated from the deposited mass and the measured thickness, varies between 30 and 50%. The mechanical stability of films deposited for longer duration ((Td)=550 s) is found to decrease, with some parts detaching from the substrate upon rinsing, which causes the deposited mass to level off. The cross-section SEM micrographs of FIGS. 1A to 1D also show numerous voids along the observed dendritic structure of the films, most of these voids extending from the film surface to the underlying Ni plate substrate.

In top-view SEM micrographs (FIGS. 1E to 1H), micrometer-sized pores are observed at the surface of the films, with pore diameter in a range between about 10 and about 30 μm. Lower pore density and larger pore diameters are obtained for increased deposition times. In all cases, the pore walls exhibit a highly porous cauliflower-like secondary structure, with much smaller pore diameters, typically less than 500 nm. The structure seen in FIG. 1 was observed over the entire 1 cm²_{geometric} surface area of the deposits. Similar Ni structures may be formed on substrates with larger geometric surface areas.

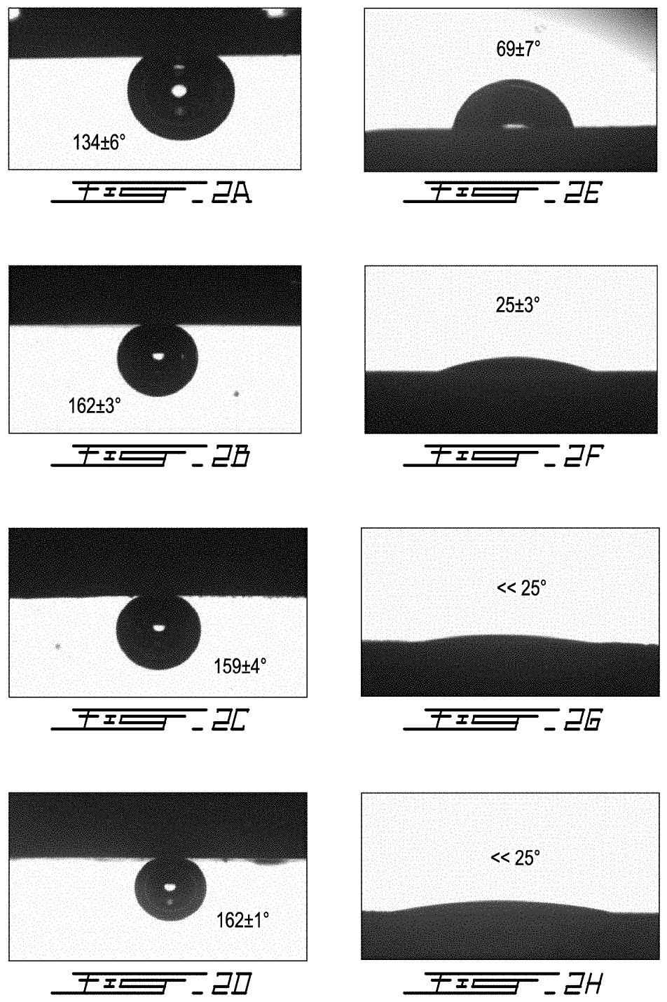

Contact angle measurements on captive air bubbles at the surface of Ni_{DHBT} films were performed and results are displayed in FIG. 2. The contact angle of air bubbles is seen to increase from about 139° for Ni plate to about 160° for Ni_{DHBT} films, independently of the DHBT deposition times. Water contact angle measurements were also performed as a measure of the hydrophilicity of Ni_{DHBT} films, as an assessment of wetting capacity of the porous structure of Ni_{DHBT} films and of the contact of the porous structure of Ni_{DHBT} films with surface-active sites. To do so, sessile drop experiments were performed (5 μL of deionized H₂O) (see FIG. 2). Ni_{DHBT} films presented superhydrophilic properties, with contact angles well below 25°, sign of the strong affinity of Ni_{DHBT} films toward water molecules, to be contrasted with angle values of 30° and 42° recently reported [43]. In contrast, much larger contact angles (69°) are obtained herein on Ni plate.

According to the Wenzel's model, the apparent contact angle on a rough surface, θᵣ, is given by the following relation:

$$cos {θ}_{r} = r cos θ with cos θ = \frac{{α}_{13} - {α}_{12}}{{α}_{23}} \qquad ( 3 )$$

where α₁₂, α₁₃, and α₂₃ are the interfacial tensions of the solid-liquid, the solid-gas, and the liquid-gas interface, respectively, r is the ratio of the true area of the solid surface to the apparent area, and θ is the Young contact angle as defined for an ideal surface of the same material. Because r is by definition greater than or equal to 1, it is determined from relation 3 above that roughness enhances the wetting/non-wetting intrinsic properties of a material, the extent of which is defined by the value of r.

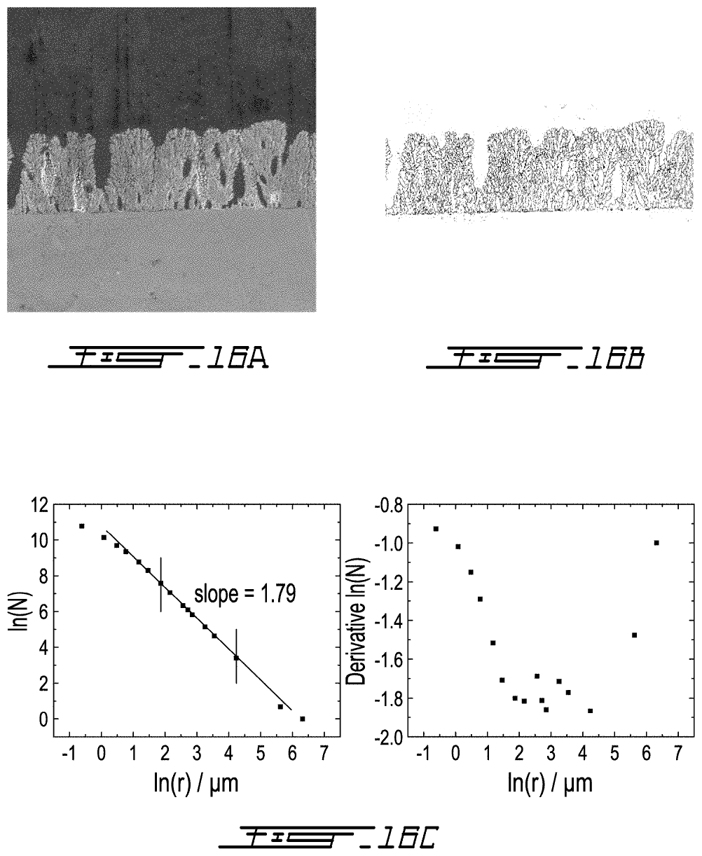

An alternative way to characterize porous solid surfaces is provided by the following relation (4) [44, 45]:

$$cos {θ}_{f} = {( \frac{L}{l} )}^{D - 2} cos θ \qquad ( 4 )$$

where L and l are the upper and lower limit lengths of fractal behavior, respectively, and D is the fractal dimension of the solid surface, with 2≤D≤3. A fractal analysis based on the SEM cross-section image of the thicker Ni_{DHBT} film (Td)=450 s) was conducted. The SEM cross-section image of a Ni_{DHBT} sample (Td)=450 s) was taken at ×500 magnification as shown in FIG. 16A. The original image was firstly converted to 8-bit grayscale and then was segmented into features of interest and background by setting the threshold interval in-between 105 and 255. The boundary of the structure was extracted by a Sobel edge detector in image software (“find edge”). Then, the 2D contour image was skeletonized to one pixel wide. The final processed image is shown in FIG. 16B. The 2D contour fractal dimension was analyzed by a box counting tool. The box size was set between 1 to 1024 pixels which corresponds to a scale from 0.5 μm to 554 μm in the original image. The count of boxes containing pixels at different box sizes is presented in an ln-ln-plot (FIG. 16C) of count N versus box size r. Over a certain local range of length scales the box count shows linear relationship with box size, indicating that porous metal materials have obvious fractal characteristics. To determine the largest and the smallest size limits of the fractal behavior of the surface as well as the exact 2D fractal dimension, the derivatives of ln(N) in function of ln(r) were extracted from the ln-ln plot and is shown in FIG. 16D. The derivative shows a plateau with a value of 1.79±0.05 in the interval of 6.49 μm to 69.19 μm. Thus, the 2D fractal dimension D2 is estimated to be 1.79±0.05 and the upper and lower limit lengths of fractal behavior are 69.19 μm and 6.49 μm respectively. The fractal dimension D of the surface is obtained as D=2D+1=2.79.

The value of (L/l)^{D-2} obtained is 6.5. However, using the water contact angle of Ni plate as a reference, Relation 4 above predicts that cos θ_{f}=2.3, which is obviously not possible. This discrepancy may be caused by air trapped beneath the water droplet. In these conditions, wetting follows the Cassie-Baxter wetting regime and Relation (4) can be re-written as follows (5) [46]:

$$cos {θ}_{f} = {( \frac{L}{l} )}^{D - 2} {f}_{s} cos θ + {f}_{s} - 1 \qquad ( 5 )$$

with fₛ the fraction of the surface that is wetted by water.

In this case, assuming that fₛ=0.6 considering that the water droplet is wetting 60% of the Ni_{DHBT} film underneath, the contact angle measurements are in agreement with the fractal analysis. In the Cassie-Baxter wetting regime model (Relation 5), the Ni_{DHBT} films are treated like porous materials and partial spontaneous invasion of liquid inside the texture of the Ni_{DHBT} films occurs through capillary action. Further decrease of O_{f} may be achieved by increasing (L/l)^{D-2} and/or fₛ, by selecting the Ni_{DHBT} deposition conditions.

The above discussion on the wetting property, based on the ex-situ contact angle observations under the air entrapment assumption used in Relation 5 as opposed to in-situ observations on the contact angle measurement in real gas evolution situations, reflects hydrophilic properties of Ni_{DHBT} films, or efficiency of Ni_{DHBT} films in releasing the bubbles.

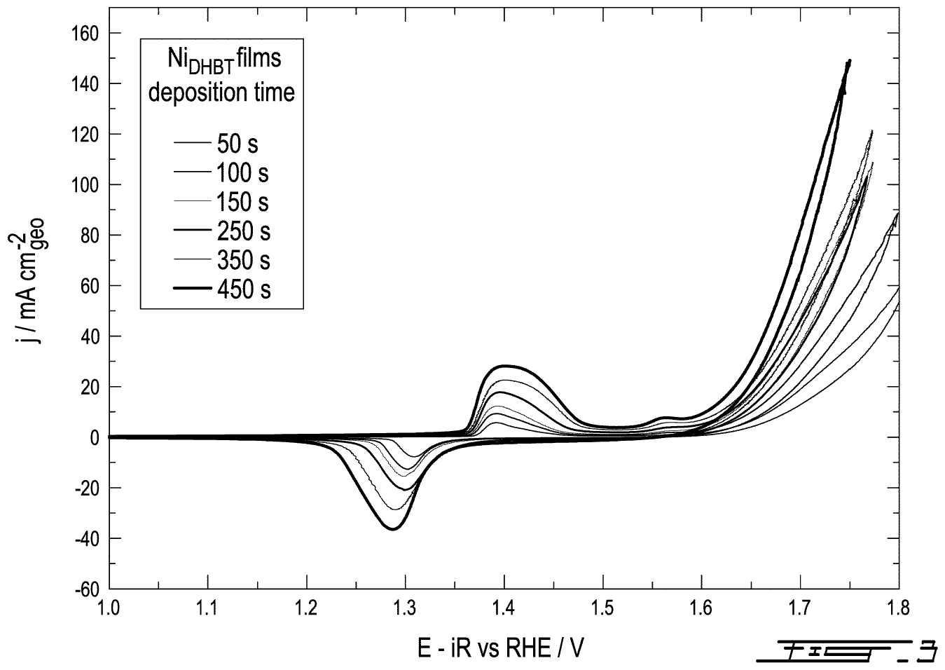

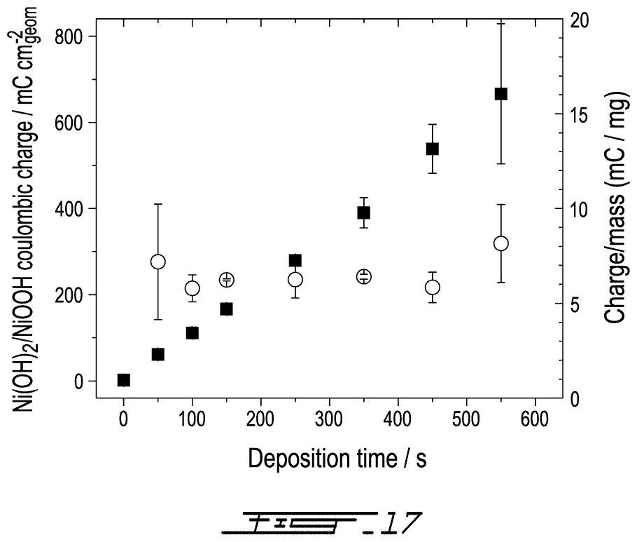

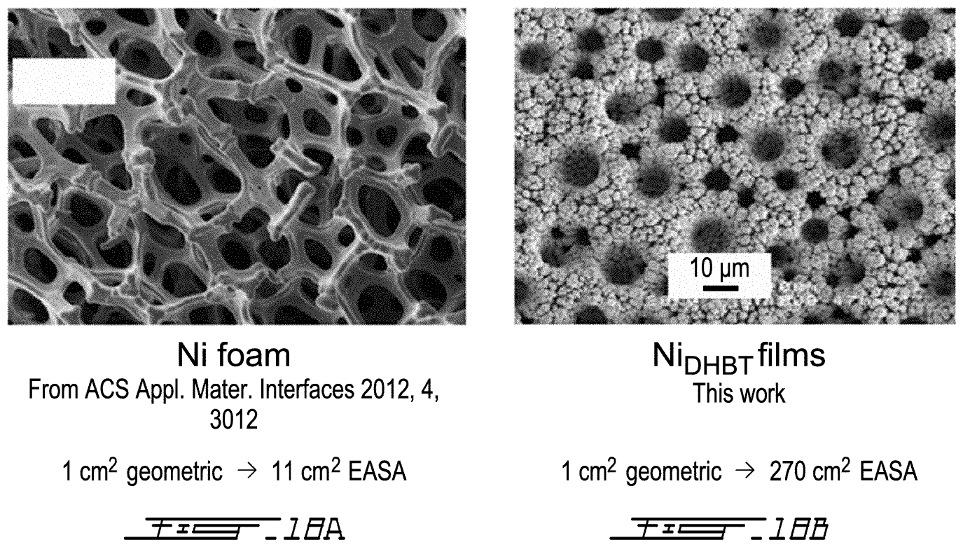

The electrochemical properties of porous Ni_{DHBT} coatings were first determined through CV measurements. Following repetitive potential cycles, as will be detailed hereinbelow, until the formation of a hydrous Ni oxide deposit was achieved, steady-state CV profiles were obtained as shown in FIG. 3. All Ni_{DHBT} CVs exhibit a large oxidation, at about 1.41 V, and reduction peak, at about 1.28 V, whose intensities grow with the film thicknesses. These peaks are discussed hereinbelow. For each Ni_{DHBT} electrode, the ratio between the anodic (Qₐ) and the cathodic (Q_{c}) coulombic charge of this redox transition remains similar, with a mean value of about 1.00±0.13. Qₐ values increase continuously from 62±4 mC cm⁻² for a deposition time (Td)=50 s to 539±57 mC cm⁻² for a deposition time (Td)=450 s (FIG. 17). These values correspond to electrochemically active surface enhancement factors of about 30 and 270, respectively, considering the Qₐ value of a commercial Ni plate as a reference, of 2.1±0.1 mC cm⁻²). Once normalized to the deposited mass, m (FIG. 17), the ratio Qₐ/m is remarkably constant. This is a clear indication that the material deposited at the beginning of the deposition period is not occluded by the material deposited at the end of the deposition period. This is consistent with the presence of numerous small (<500 nm) and large (between about 10 and about 30 μm) pores seen in FIG. 1. For comparison, there is a factor of about 25 increase between the Qₐ values of Ni foams and Ni_{DHBT} films (FIG. 18).

The good mechanical stability, highly porous structure and increased capacity of the Ni_{DHBT} films to store charge provides for material and/or substrate for low-cost pseudo supercapacitor devices, as charge density values in excess of 500 mC cm⁻² observed for Ni_{DHBT} of 450 s are well above charge density values reported recently in the art for hierarchical porous Ni/NiO electrodes [48]. Higher electrochemically active surface areas were obtained for Ni_{DHBT} of 550 s (660 mC cm⁻²); with mechanical stability issues, considering some part of the deposits might detach from the substrate, causing a large dispersion in the data (see the error bar in FIG. 17). The mechanical stability of the thickest films may be improved by a subsequent heat-treatment through sintering of Ni grains, therefore allowing the preparation of adherent films with larger electrochemically active surface areas.

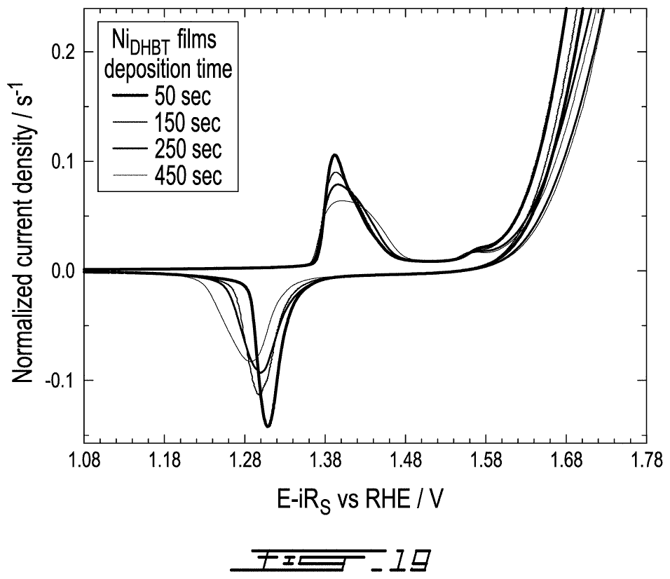

On thinner Ni_{DHBT} films (Electrodeposition times (Td)=50 s), the main oxidation peak is centered at about 1.39 V. It corresponds to the well-known α-Ni(OH)₂/γ-NiOOH transition [50, 49]. There is also a shoulder at about 1.43V, which is attributed to β-Ni(OH)₂/β-NiOOH transition. While both contributions are observed as the Ni_{DHBT} film thickens (FIG. 19), the relative intensity of the β-Ni(OH)₂/β-NiOOH transition increases steadily from the thinnest to the thicker films, as can be assessed from the relative intensity at 1.39 and 1.43 V. The position and the relative intensity of both transitions do not vary with the scan rate (not shown).

All Ni_{DHBT} films exhibit an additional oxidation wave at about 1.56 V, whose intensity increases with thickness. This oxidation wave may be attributed to formation of Ni (IV) species, potentially at the edges of γ-Ni(OH)₂/γ-NiOOH domains [52, 50]. At more positive potentials (E ≥1.60 V), O₂ evolution occurred with high current densities, which systematically increased upon increasing Ni_{DHBT} film thickness. For Ni_{DHBT} films of deposition times 50 s and 450 s, current density values of about 25 mA cm⁻² were obtained at 1.72 V and 1.64 V, respectively. Conversely, at 1.64 V, the OER current density increased by a factor of five, from 5 mA cm⁻² to 25 mA cm⁻², upon increasing Ni_{DHBT} deposition times from 50 s to 450 s.

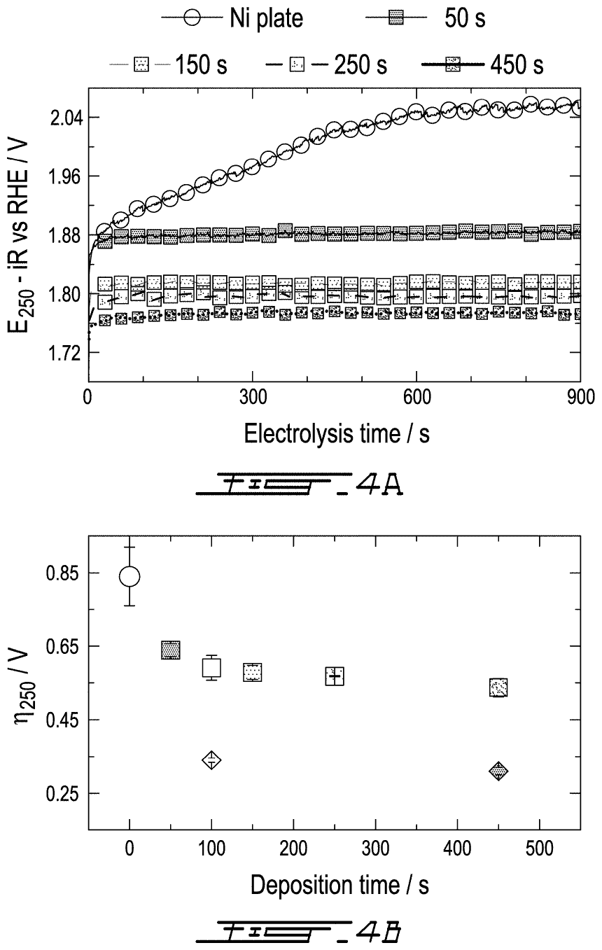

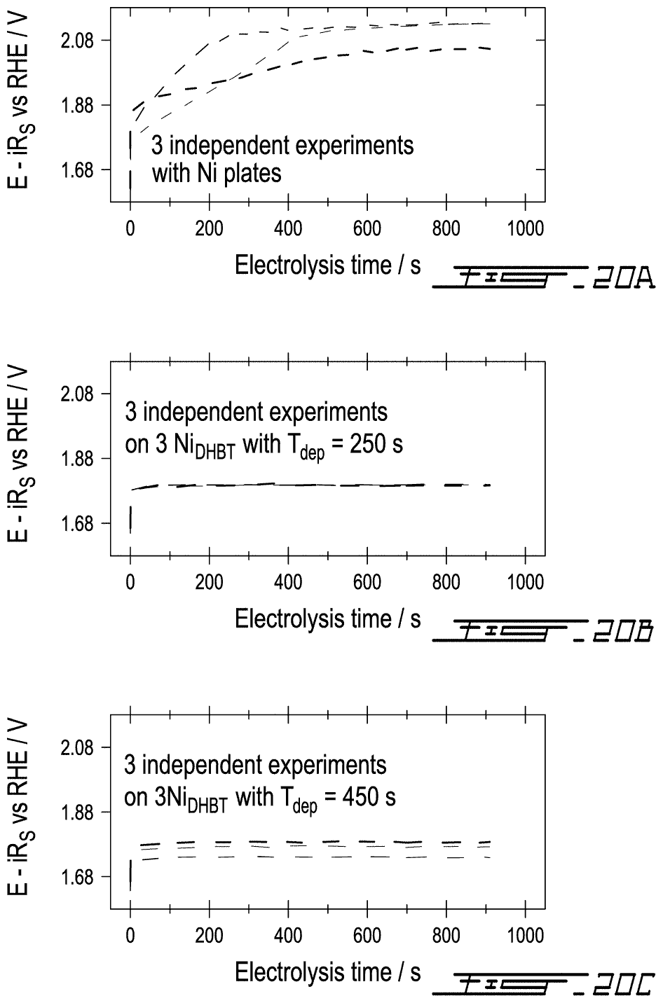

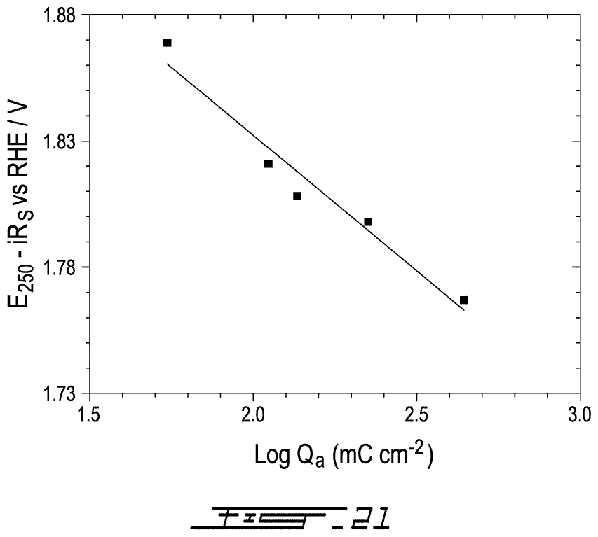

Galvanostatic experiments (250 mA cm⁻²) were performed on Ni_{DHBT} electrodes in 1 M KOH. The corresponding results are presented in FIG. 4A. Stable potentials were obtained for Ni_{DHBT} electrodes right from the beginning of the tests. In contrast, a gradual increase of the potential was observed for bare Ni plates during the first 10 minutes of electrolysis. For longer electrolysis periods, the OER potential of Ni plates stabilized at 2.05 V. The electrochemical behaviors presented in FIG. 4A were reproducibly obtained for a minimum of three different Ni electrodes (see FIG. 20). In FIG. 4B, the iR-corrected overpotentials reached after 15 minutes of electrolysis at +250 mA cm⁻², η₂₅₀, being plotted with respect to the deposition time. There is about 300 mV difference between η₂₅₀ of Ni plate and best performing Ni_{DHBT} films. As shown previously, Qₐ is directly proportional to the deposition time (FIG. 17) and can be used as an indirect measure of the electrochemically active surface area. FIG. 21 shows that E₂₅₀ values of Ni_{DHBT} films scales linearly with Qₐ plotted on a semi-logarithmic scale, which is expected if all the material making up the Ni_{DHBT} films is involved in the OER. This suggests that, even at high current density (250 mA cm⁻²) and for the thicker films, the electrolyte has access to the whole porous structure and that the O₂ bubbles do not lead to a decrease of the available Ni catalytic sites.

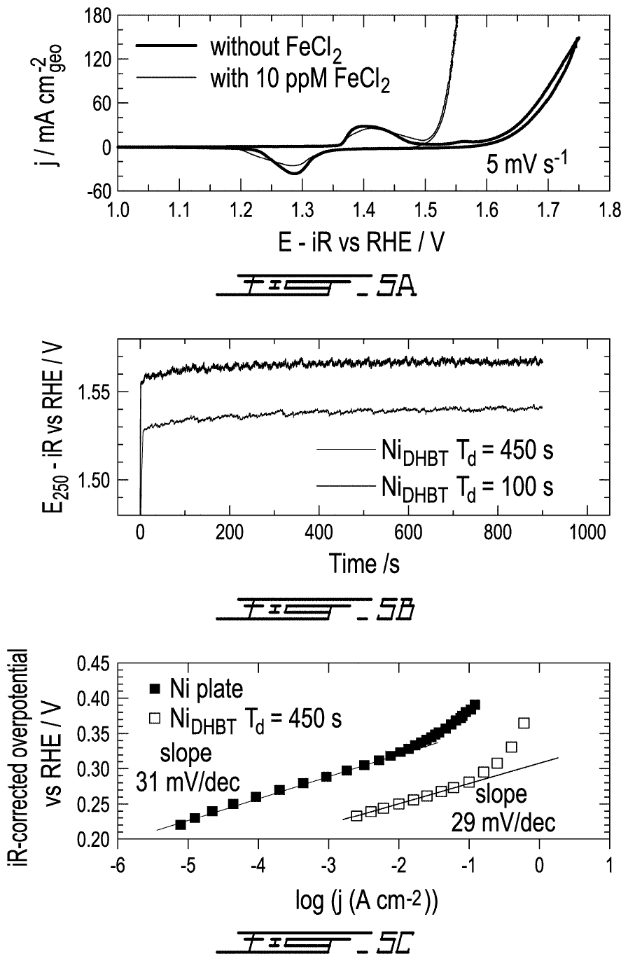

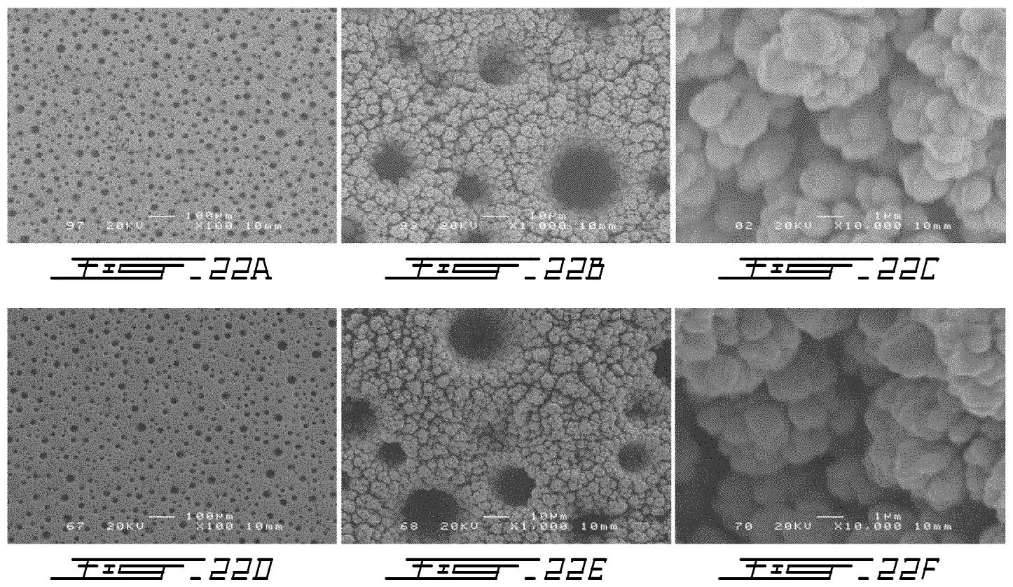

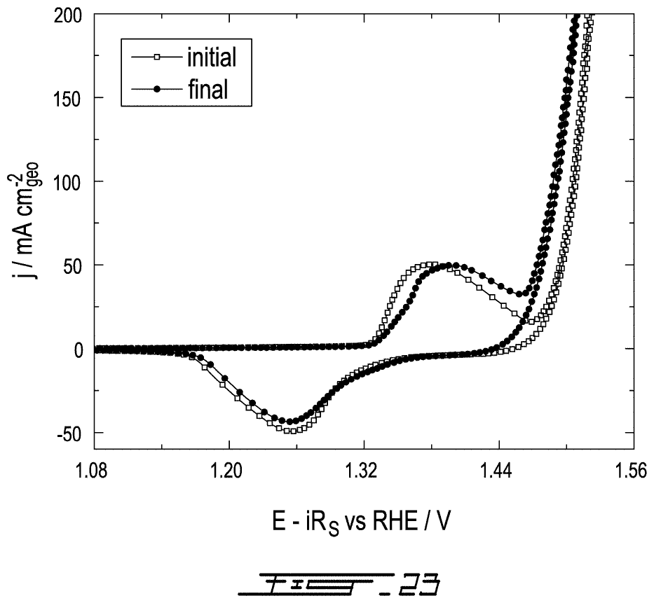

The observation of a redox transition at 1.56 V before the onset for the OER in FIG. 3 may be interpreted as a clear signature of Ni(OH)₂ aged or cycled in a rigorously Fe-free electrolyte [52, 51]. Considering that, in contrast, known studies indicate that cycling or aging of Ni(OH)₂ in Fe-contaminated KOH solution, even at the ppm level, leads to a huge improvement of the activity for the OER, potential cycling of Ni_{DHBT} electrodes 1 M KOH electrolyte spiked with 10 ppm of FeCl₂ was performed. As seen in FIG. 5A, the onset potential for the OER is shifted negatively by at least 100 mV in presence of Fe impurities, pointing toward a reduction of the energy barriers of some of the intermediates in the OER process. This occurs even if the charge under the redox peaks centered at about 1.39 V is hardly changed although the shape of the oxidation and reduction peaks are slightly modified, suggesting the surface density of active sites was not changed. The Fe content of these electrodes remains low (0.6%, as determined by EDX analysis). Galvanostatic curves (j=250 mA cm⁻²) recorded in 1 M KOH spiked with 10 ppm FeCl₂ are shown in FIG. 5B. These potential vs time curves are as stable as they are in the absence of Fe impurities. The two sets of SEM micrographs taken before and after electrolysis are virtually undistinguishable from one another (FIG. 22), indicating that the electrode structure is morphologically stable even under vigorous O₂ evolution. This is consistent with the CVs of electrodes taken at the beginning and the end of the polarization period being almost superimposed on each other (FIG. 23).

FIG. 5C shows the steady-state iR-corrected potential vs log(j) curves (Tafel plot) on both Ni plate and a NiDHBT electrode (Td)=450 s with 10 ppm FeCl₂ in the electrolyte. The Tafel slopes are 31 and 29 mV/dec for Ni plate and Ni_{DHBT}, respectively, which indicates that the mechanisms responsible for the OER are the same on both electrodes. Even if the Ni_{DHBT} films have an electrochemically active surface area (EASA) 270× larger than a Ni plate, Fe impurities interact with the Ni sites at this extended surface in the same way they are with Ni sites distributed on a flat surface. Part of the reason for this behavior may be related to the open structure of Ni_{DHBT} films that is not hampering the diffusion of Fe impurities through the film and their interaction with Ni sites. This assumption is supported by the results of FIG. 17, showing that the coulombic charge, Qₐ, of the redox transition at about 1.41 V scales linearly with the deposition time (Td), and thus with the mass of the film. The data of FIG. 5C also show that, in the “Tafel region”, there is a factor of about 230× difference of the apparent current density between both substrates, very close from the 270-time increase of the EASA determined previously. This means that most of the extended surface area of Ni_{DHBT} films is modified by Fe impurities and is active for the OER.

Activities for the OER is typically assessed in the art by the potential required to oxidize water at a current density of 10 mA cm⁻², a metric relevant to solar fuel synthesis. As shown in FIG. 5C, the overpotential at 10 mA cm⁻², 1710, of the Ni_{DHBT} film optimized herein is 250 mV, which is 70 mV lower than best performing materials reported in the art for most promising electrode materials. In presence of 10 ppm FeCl₂, η₂₅₀ values as small as 310 mV were reached in present experiments for the Ni_{DHBT} electrode with (Td)=450 s. In comparison, the recent art reported an OER overpotential at 100 mA cm⁻², η₁₀₀, of 312 mV in 1M KOH for iron-doped nickel hydroxide prepared at room temperature on Ni foam [64] which is already better than results reported in previous works [65, 66]. However, from the data of FIG. 5C, this is still 32 mV larger than the overpotential recorded on Ni_{DHBT} at the same current density. Elsewhere, FeCoNi deposited on Ni foam were shown to deliver 75 mA cm⁻² at an overpotential of 320 mV in 1 M KOH [64], which is 44 mV larger than at the present Ni_{DHBT} films (1775=276 mV from FIG. 5C).

Several reasons may explain the OER performances of the present Ni_{DHBT} films. The increased electrochemically active surface area of Ni_{DHBT} films, as compared to Ni plates, is in part responsible for the improved OER performance. As stated previously (FIG. 21), the electrochemically active surface area of Ni_{DHBT} films is fully accessible to the electrolyte and participates in the O₂ evolution reaction. It is to be noted that this measure of the active area was performed in a potential region where no gas evolution is occurring. Owing to the porous structure of Ni_{DHBT} films, it may have been expected that, at more positive potential in the OER region, O₂ bubbles would increase the electrolyte resistance and/or be responsible for occlusion of some of the pores. Surprisingly, this is not what was obtained, and the EIS data of the present disclosure shows that the double layer capacitance is constant in the potential region where the 29 mV/decade Tafel slope is observed. This indicates that occlusion of Ni active sites by O₂ bubbles is not a limiting factor.

The low Tafel slope (29 mV/decade) appears as an important factor contributing to the performance of the NiDHBT films. On NiDHBT films, the 29 mV/decade Tafel slope is observed over a range of current densities that far exceed that of Ni plate. Indeed, the “low Tafel slope region” extends up to 100 mA cm⁻² on Ni_{DHBT} films while it is limited to 5 mA cm⁻² on Ni plate. This striking difference is partly responsible for the increased performance of the Ni_{DHBT} films and is to be related to their specific morphologies.

The morphology of the electrodes is here shown as impacting the adhesion force of gas bubbles to the surface and the detachment diameter of the same gas bubbles upon release. Indeed, both the adhesion force and the detachment diameter of gas bubbles are diminished through nanostructuring of the electrode surface. According to the Fritz correlation, there is a linear relationship between the gas bubble detachment diameter from a surface and its water contact angle. As mentioned hereinabove, the water contact angle decreases from 60° to less than 25° as a result of the fractal geometry of the Ni_{DHBT} electrode. Enhanced air bubble contact angle, which is a direct consequence of increased hydrophilicity, translates into smaller bubble adhesive forces on the electrode surface, and smaller residency time, along with smaller radius of the contact plane between air bubble and the electrode surface, and thus larger contact area between the electrolyte and the electrode active sites. There are thus signs of significant decrease of the adhesion force and detachment diameter of gas bubbles resulting from nanostructuring of the electrode, which may explain the morphological stability of Ni_{DHBT} films under vigorous oxygen evolving conditions.

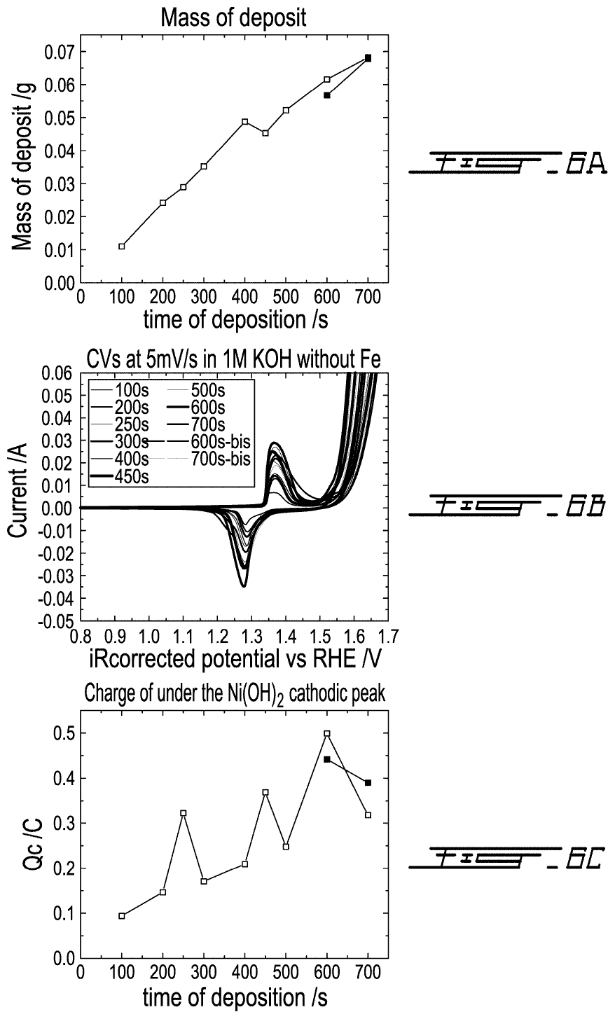

There is now shown, in relation to FIGS. 6 to 14 that porous structure of Ni can be replicated conformally on a range of Ni materials by the present dynamic hydrogen bubble template electrodeposition method (DHBT). Nouveau inventif

FIGS. 6 to 11 show optimization of Ni DHBT deposition on pressed Ni Foam.

FIGS. 6A-6C show raw data without normalization for the geometric surface area (0.4 cm²) of the substrate. Deposition of Ni DHBT was done on 0.4 cm² Ni foams at deposition current=−2 A cm⁻² with 9 different deposition times, as well as two repeats. The deposited mass varies more or less linearly with the deposition time. CVs were measured and the charge under the cathodic peak, Qc, was measured. Qc is shown to increase with the deposition time.

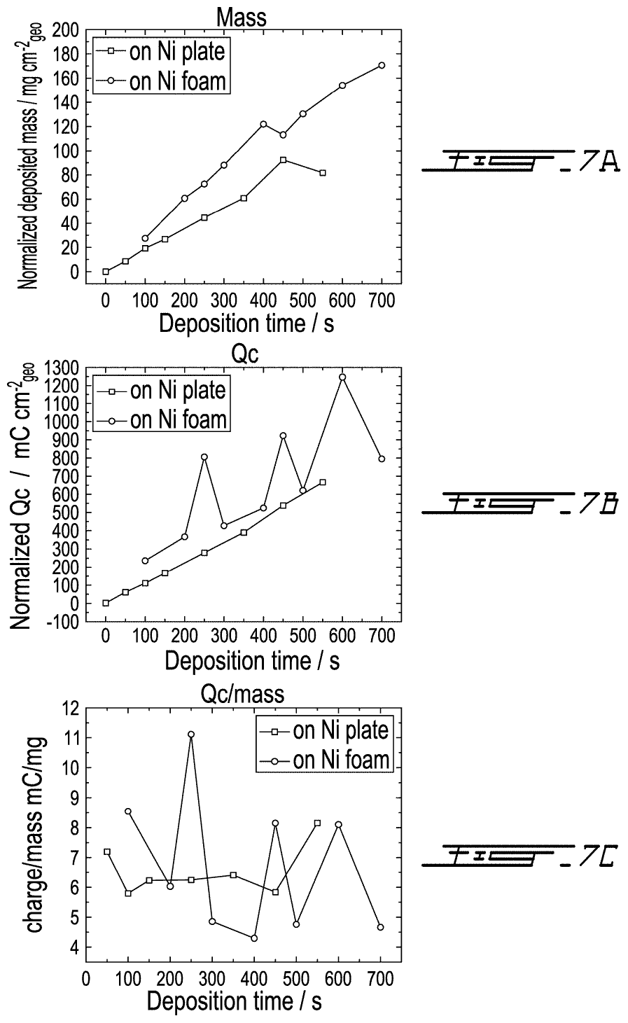

FIGS. 7A-7C show a comparison of Ni DHBT deposited on Ni plate and Ni foam with data of the current art (ACS Applied Energy Materials 2 (2019) 5734-5743). The deposition time was varied.

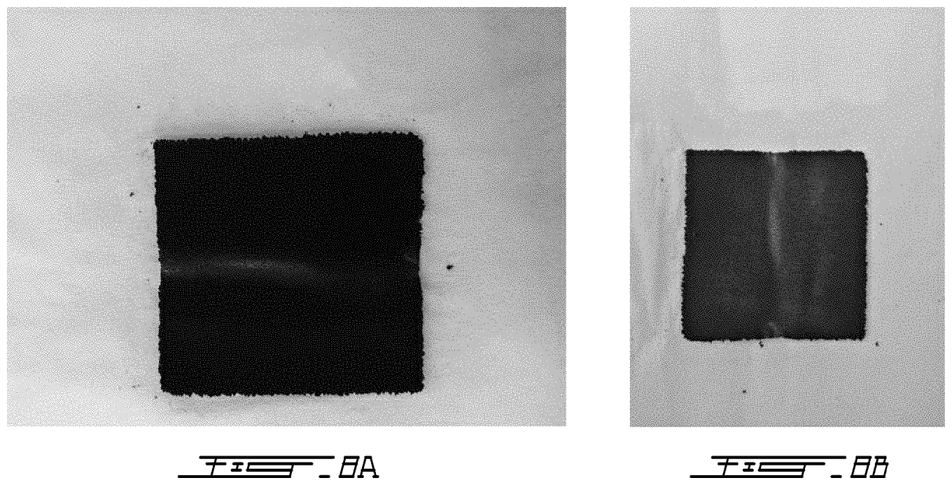

FIGS. 8A-8B show what, on the front side facing the counter electrode (FIG. 8A) and, on the back side not facing the counter electrode (B).

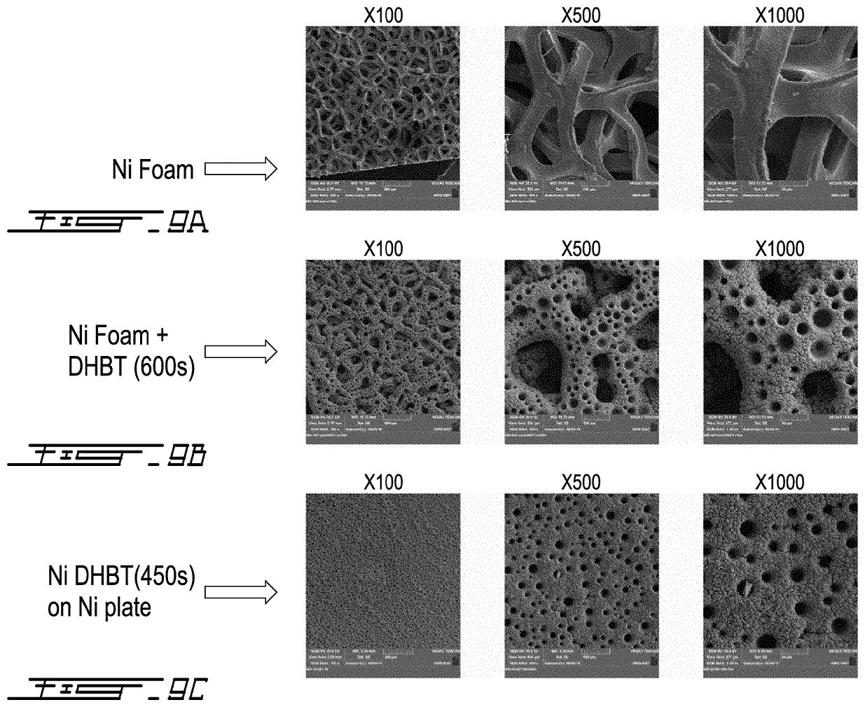

FIGS. 9-C show SEM micrographs of Ni DHBT deposited on Ni foam.

As evidenced from FIGS. 6-9, Ni DHBT were thus deposited on pressed Ni foams, and the structure of the film thus obtained is similar to Ni DHBT film prepared on flat Ni plate.

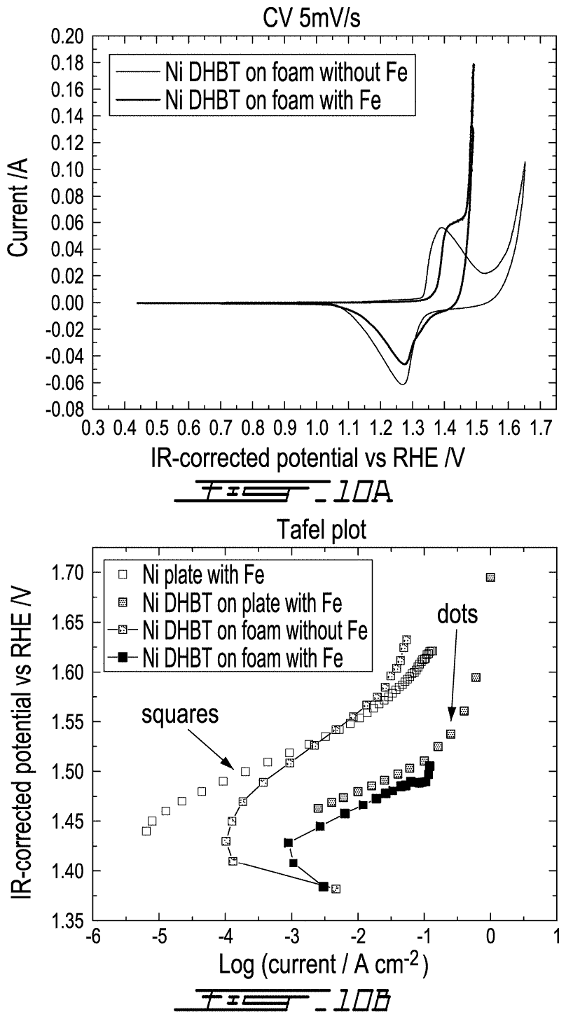

FIG. 10—show, for Ni DHBT on Ni Foam, electrochemical characterization in 1 M KOH at 22 C with and without 10 ppm FeCl₂. Several electrochemical tests were performed, the result of a few of a number of them are described hereinbelow.

FIGS. 10A-10B show Ni DHBT on foam, with and without Fe. The same electrochemical protocol was repeated four times, the results of the last test are shown. In the right-hand panel, the squares and the dots are for Ni DHBT deposited on a Ni plate previously reported (ACS Applied Energy Materials 2 (2019) 5734-5743).

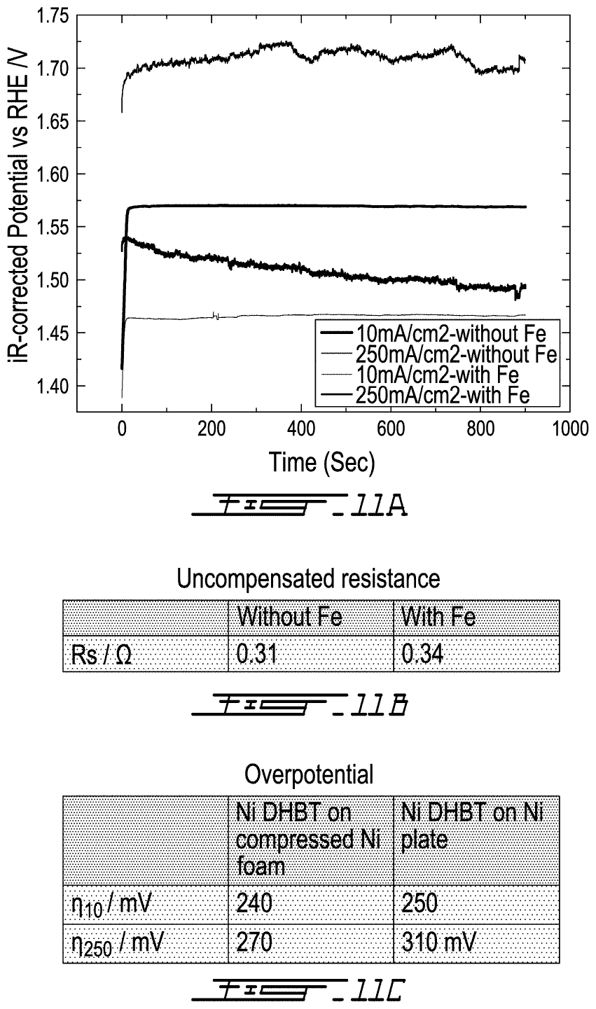

FIGS. 11A-11C show short-term chronoamperometric curves at 10 and 250 mA cm² in 1 M KOH at 22 C with and without 10 ppm FeCl₂. The data of Ni DHBT deposited on Ni plate and Ni foam electrodes are shown.

FIGS. 10 and 11 11, show further evidence of replication of porous structure of Ni conformally on a range of Ni materials. by the dynamic hydrogen bubble template electrodeposition method (DHBT). Noiuveau inventif.

Two Ni DHBT deposits were fabricated on large area foam electrodes. One was electrochemically tested without Fe (sample 1) and the other one with Fe in solution (sample 2). After all the electrochemical tests were performed, sample 1 was put in contact with a KOH electrolyte containing FeCl₂.

Thus, as illustrated 6-11, the specific surface area of the Ni DHBT coating on pressed Ni foam was optimized by controlling the time of electro-deposition. The electrochemical active surface area of different Ni DHBT coatings was determined by the coulombic charge, Qₐ, of the redox transition observed at ca 1.41 V, obtained from CV profiles. It was shown that at deposition time of 600 s the Ni DHBT coating on pressed Ni foam reaches an optimal specific surface area. Then, the optimized deposition condition was applied on large pressed Ni foam (5.75 cm²). The morphology of the as prepared Ni DHBT coating is shown conformable to the morphology obtained on Ni plate.

Further catalyzing the Ni DHBT coating on pressed Ni foam with small amount of more active materials such as Fe²⁺ was also shown. Catalization of Ni DHBT was achieved through spiking of the 1M KOH electrolyte with a small amount of FeCl₂. Adsorption of Fe cations at the electrode surface decreases the OER onset potential and enhances the OER kinetics.

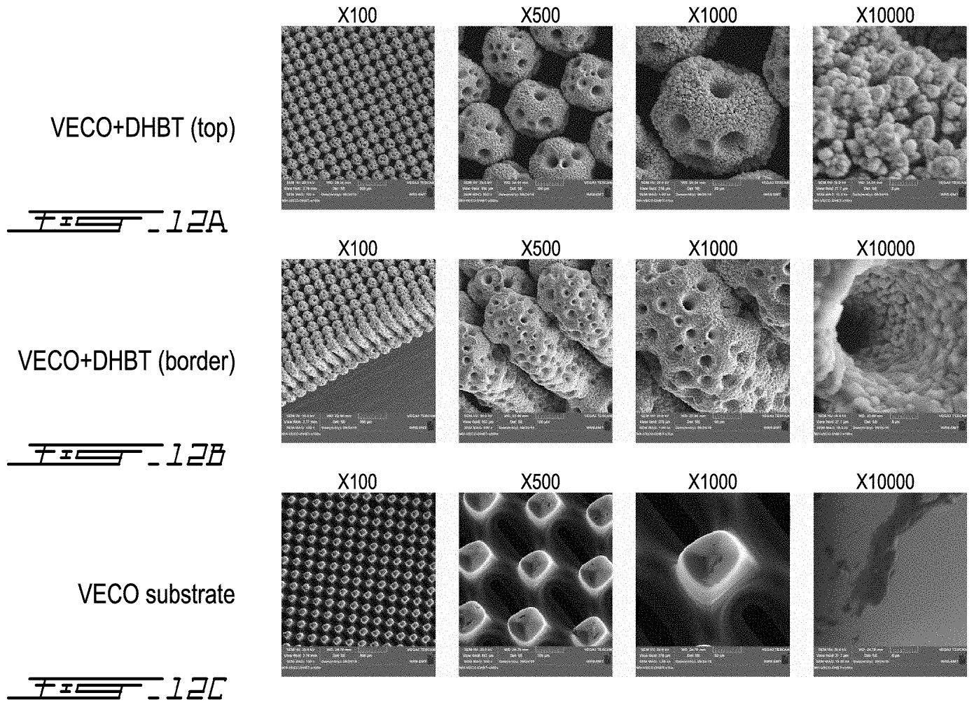

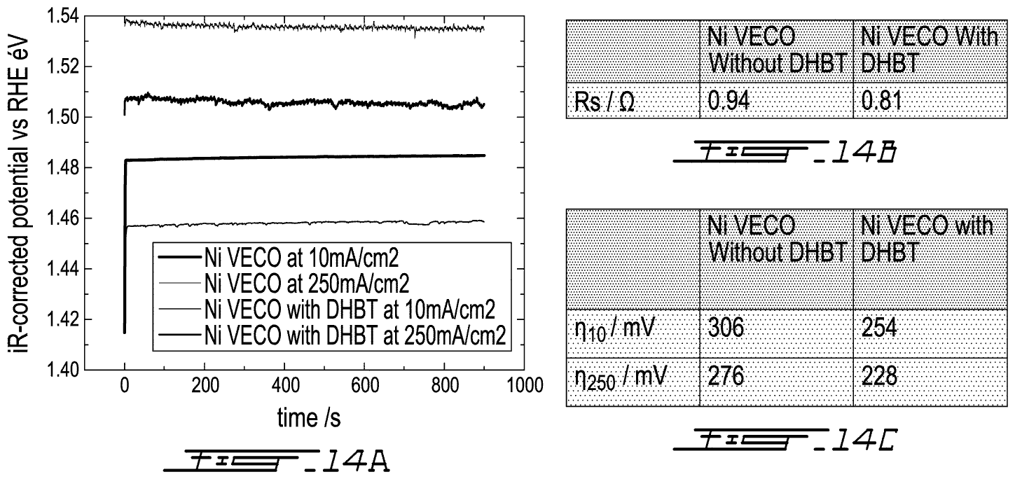

FIGS. 12 to 14 relate to Ni VECO samples. SEM micrographs of Ni DHBT deposited on Ni VECO samples of FIG. 14 show that NI DHBT is deposited conformally on the substrate.

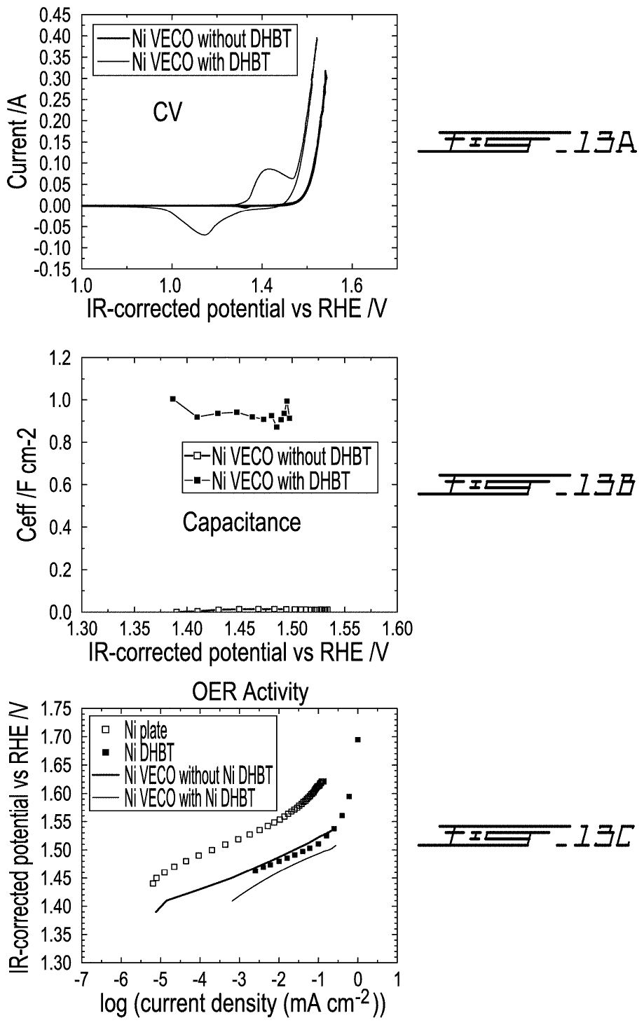

FIG. 13 show Ni VECO with and without Ni DHBT tested in 1 M KOK with 10 ppm FeCl₂. As may be seen in FIG. 13, the Ni electrochemically active surface area is increased by 50 (FIGS. 13A-B), and there is a significant increase of the current density for the oxygen evolution reaction for the range of electrode potential (FIG. 13C).

FIG. 14 show, Ni VECO with and without DHB decrease of the overpotential for the oxygen evolution reaction at 10 and 250 mA cm⁻².

As shown in FIGS. 12 to 14, Ni DHBT is deposited on Ni Veco sample and the Ni DHBT deposit is conformal. Ni DHBT coating was applied on Ni VECO textured sample. Still the morphology of the deposited Ni DHBT coating is identical to the morphology obtained on Ni plate.

Robust and mechanically stable electrodes are thus fabricated starting from a cost-effective and sustainable material. Ni_{DHBT} films are wetted by the electrolyte (fₛ=0.6), resulting in an increased electrochemically active surface area. They also exhibit a superaerophobic character resulting in in increased air bubble contact angle and reduced air bubble adhesive force, both factors further contributing to maximize the surface area contact between the active sites of the electrode and the electrolyte even in conditions of strong O₂ evolution. This results in a decreased overpotential even in conditions of vigorous O₂ evolution. On this matter, it is worth remembering that Ni_{DHBT} films are prepared by electrodeposition in conditions where hydrogen evolution occurs concomitantly with Ni metal deposition. As mentioned hereinabove, the faradaic efficiency for Ni deposition is close to 30%, which means that a large fraction of the current is used to generate hydrogen gas that escapes the electrode in the form of gas bubbles. As a result, right from their formation, Ni_{DHBT} films are templated in such a way that gas bubbles can freely escape the growing film without causing any damage to its structure. The existence of several paths through which gas bubbles escape without causing damage to the film is shown to contribute in the stability of the Ni_{DHBT} films. From a broader viewpoint, such gas bubble-architecture materials provide active and stable catalysts for other gas evolving electrochemical reactions.

Dynamic hydrogen bubble templating is used to fabricate Ni_{DHBT} films with a fractal structure, which exhibits improved OER properties compared to Ni plate. Fabricated Ni_{DHBT} films are highly porous and have an electrochemically accessible surface area which is an increased by a factor of 270 as compared to the underlying Ni plate. They are mechanically robust and resist degradation under vigorous oxygen evolution. In presence of 10 ppm FeCl₂, OER overpotential at 250 mA cm⁻² is only 310 mV, contributed by both the porous nature of the deposit and the superaerophobic characteristic of the fractal Ni films, which leads to an increase of the contact angle of a trapped air bubble and a decrease of the adhesion force of O₂ gas bubbles. Industrial applications of these NiDHBT templates depends on the availability of suitable pieces of equipment for dynamic hydrogen bubble templating on substrates with larger geometrical surface area.

There is thus provided a method of dynamic hydrogen bubble templating of Ni (Ni_{DHBT}) electrodes to fabricate highly porous films with enhanced properties towards the oxygen evolution reaction (OER). Upon controlling the electrodeposition conditions, Ni films with a microporous primary structure and highly porous cauliflower-like secondary structure are formed. These films are able to develop an extended electrochemically active surface area, up to 270-fold increase compared to Ni plate. They exhibit stable overpotential I (η₂₅₀=540 mV) at j=250 mA cm⁻²_{geometric} in 1M KOH electrolyte, which is 300 mV less positive than at Ni plate. Fe incorporation onto these Ni_{DHBT} structures can further lower OER overpotentials to η₂₅₀=310 mV. Ni_{DHBT} films are remarkably stable over prolonged polarization and are characterized by a low Tafel slope (29 mV/decade) that extends up to j=100 mA cm⁻²_{geometric}, contributed by both superaerophobic characteristics with a contact angle of about 160° between the surface and an air bubble and superhydrophilic characteristics with less than 25° between the surface and a water droplet.

The scope of the claims should not be limited by the embodiments set forth in the examples but should be given the broadest interpretation consistent with the description as a whole.

### REFERENCES

1. Suen, N.-T.; Hung, S.-F.; Quan, Q.; Zhang, N.; Xu, Y.-J.; Ming Chen, H. Electrocatalysis for the Oxygen Evolution Reaction: Recent Development and Future Perspectives. Chem. Soc. Rev. 2017, 46 (2), 337-365.
2. Cheng, Y.; Jiang, S. P. Advances in Electrocatalysts for Oxygen Evolution Reaction of Water Electrolysis—from Metal Oxides to Carbon Nanotubes. Prog. Nat. Sci.: Mater. Int. 2015, 25 (6), 545-553.
3. Suntivich, J.; May, K. J.; Gasteiger, H. A.; Goodenough, J. B.; Shao-Horn, Y. A Perovskite Oxide Optimized for Oxygen Evolution Catalysis from Molecular Orbital Principles. Science 2011, 334 (6061), 1383-1385.
4. Li, M.; Xiong, Y.; Liu, X.; Bo, X.; Zhang, Y.; Han, C.; Guo, L. Facile Synthesis of Electrospun MFe2O4 (M=Co, Ni, Cu, Mn) Spinel Nanofibers with Excellent Electrocatalytic Properties for Oxygen Evolution and Hydrogen Peroxide Reduction. Nanoscale 2015, 7 (19), 8920-8930.
5. Kang, Q.; Vernisse, L.; Remsing, R. C.; Thenuwara, A. C.; Shumlas, S. L.; McKendry, I. G.; Klein, M. L.; Borguet, E.; Zdilla, M. J.; Strongin, D. R. Effect of Interlayer Spacing on the Activity of Layered Manganese Oxide Bilayer Catalysts for the Oxygen Evolution Reaction. J. Am. Chem. Soc. 2017, 139 (5), 1863-1870.
6. Diaz-Morales, 0.; Ferrus-Suspedra, D.; Koper, M. T. M. The Importance of Nickel Oxyhydroxide Deprotonation on Its Activity towards Electrochemical Water Oxidation. Chem. Sci. 2016, 7 (4), 2639-2645.
7. Zeng, K.; Zhang, D. Recent Progress in Alkaline Water Electrolysis for Hydrogen Production and Applications. Prog. Energy Combust. Sci. 2010, 36 (3), 307-326.
8. Cheng, H.; Scott, K.; Ramshaw, C. Intensification of Water Electrolysis in a Centrifugal Field. J. Electrochem. Soc. 2002, 149 (11), D172-D177.
9. Wang, M.; Wang, Z.; Guo, Z. Understanding of the Intensified Effect of Super Gravity on Hydrogen Evolution Reaction. Int. J. Hydrogen Energy 2009, 34 (13), 5311-5317.
10. Wang, M.; Wang, Z.; Guo, Z. Water Electrolysis Enhanced by Super Gravity Field for Hydrogen Production. Int. J. Hydrogen Energy 2010, 35 (8), 3198-3205.
11. Li, S.-D.; Wang, C.-C.; Chen, C.-Y. Water Electrolysis in the Presence of an Ultrasonic Field. Electrochim. Acta 2009, 54 (15), 3877-3883.
12. Lu, Z.; Li, Y.; Lei, X.; Liu, J.; Sun, X. Nanoarray Based “Superaerophobic” Surfaces for Gas Evolution Reaction Electrodes. Mater. Horiz. 2015, 2 (3), 294-298.
13. Li, Y.; Hasin, P.; Wu, Y. NixCo3-XO4 Nanowire Arrays for Electrocatalytic Oxygen Evolution. Adv. Mater. 2010, 22 (17), 1926-1929.
14. Lu, B.; Cao, D.; Wang, P.; Wang, G.; Gao, Y. Oxygen Evolution Reaction on Ni-Substituted Co3O4 Nanowire Array Electrodes. Int. J. Hydrogen Energy 2011, 36 (1), 72-78.
15. Lu, Z.; Xu, W.; Zhu, W.; Yang, Q.; Lei, X.; Liu, J.; Li, Y.; Sun, X.; Duan, X. Three-Dimensional NiFe Layered Double Hydroxide Film for High-Efficiency Oxygen Evolution Reaction. Chem. Commun. 2014, 50 (49), 6479-6482.
16. Liu, X.; Chang, Z.; Luo, L.; Xu, T.; Lei, X.; Liu, J.; Sun, X. Hierarchical ZnxCo3-XO4 Nanoarrays with High Activity for Electrocatalytic Oxygen Evolution. Chem. Mater. 2014, 26 (5), 1889-1895.
17. Yang, Q.; Li, T.; Lu, Z.; Sun, X.; Liu, J. Hierarchical Construction of an Ultrathin Layered Double Hydroxide Nanoarray for Highly-Efficient Oxygen Evolution Reaction. Nanoscale 2014, 6 (20), 11789-11794.
18. Lu, Z.; Zhu, W.; Yu, X.; Zhang, H.; Li, Y.; Sun, X.; Wang, X.; Wang, H.; Wang, J.; Luo, J.; Lei, X; Jiang, L. Ultrahigh Hydrogen Evolution Performance of Under-Water “Superaerophobic” MoS₂ Nanostructured Electrodes. Adv. Mater. 2014, 26 (17), 2683-2687.
19. Kong, D.; Wang, H.; Lu, Z.; Cui, Y. CoSe2 Nanoparticles Grown on Carbon Fiber Paper: An Efficient and Stable Electrocatalyst for Hydrogen Evolution Reaction. J. Am. Chem. Soc. 2014, 136 (13), 4897-4900.
20. Faber, M. S.; Dziedzic, R.; Lukowski, M. A.; Kaiser, N. S.; Ding, Q.; Jin, S. High-Performance Electrocatalysis Using Metallic Cobalt Pyrite (CoS₂) Micro- and Nanostructures. J. Am. Chem. Soc. 2014, 136 (28), 10053-10061.
21. Nam, D. H.; Kim, R. H.; Han, D. W.; Kwon, H. S. Electrochemical Performances of Sn Anode Electrodeposited on Porous Cu Foam for Li-Ion Batteries. Electrochim. Acta 2012, 66, 126-132.
22. Jeong, M.-G.; Zhuo, K.; Cherevko, S.; Kim, W.-J.; Chung, C.-H. Facile Preparation of Three-Dimensional Porous Hydrous Ruthenium Oxide Electrode for Supercapacitors. J. Power Sources 2013, 244, 806-811.
23. Niu, X.; Zhao, H.; Chen, C.; Lan, M. Enhancing the Electrocatalytic Activity of Pt-Pd Catalysts by Introducing Porous Architectures. ChemCatChem 2013, 5 (6), 1416-1425.
24. Wang, Y.; Arandiyan, H.; Scott, J.; Bagheri, A.; Dai, H.; Amal, R. Recent Advances in Ordered Meso/Macroporous Metal Oxides for Heterogeneous Catalysis: A Review. J. Mater. Chem. A 2017, 5 (19), 8825-8846.
25. Los, P.; Lasia, A.; Menard, H.; Brossard, L. Impedance Studies of Porous Lanthanum-Phosphate-Bonded Nickel Electrodes in Concentrated Sodium Hydroxide Solution. J. Electroanal. Chem. 1993, 360 (1), 101-118.
26. Lasia, A. Impedance of Porous Electrodes. J. Electroanal. Chem. 1995, 397 (1), 27-33.
27. Shervedani, R. K.; Lasia, A. Kinetics of Hydrogen Evolution Reaction on Nickel-Zinc-Phosphorous Electrodes. J. Electrochem. Soc. 1997, 144 (8), 2652-2657.
28. Hitz, C.; Lasia, A. Experimental Study and Modeling of Impedance of the Her on Porous Ni Electrodes.

J. Electroanal. Chem. 2001, 500 (1), 213-222.
29. Lasia, A. Nature of the Two Semi-Circles Observed on the Complex Plane Plots on Porous Electrodes in the Presence of a Concentration Gradient. J. Electroanal. Chem. 2001, 500 (1), 30-35.
30. Shin, H.-C.; Dong, J.; Liu, M. Nanoporous Structures Prepared by an Electrochemical Deposition Process. Adv. Mater. 2003, 15 (19), 1610-1614.
31. Shin, H.-C.; Liu, M. Copper Foam Structures with Highly Porous Nanostructured Walls. Chem. Mater. 2004, 16 (25), 5460-5464.
32. Shin, H.-C.; Liu, M. Three-Dimensional Porous Copper-Tin Alloy Electrodes for Rechargeable Lithium Batteries. Adv. Funct. Mater. 2005, 15 (4), 582-586.
33. Cherevko, S.; Chung, C.-H. Impact of Key Deposition Parameters on the Morphology of Silver Foams Prepared by Dynamic Hydrogen Template Deposition. Electrochim. Acta 2010, 55 (22), 6383-6390.
34. Li, Y.; Song, Y.-Y.; Yang, C.; Xia, X.-H. Hydrogen Bubble Dynamic Template Synthesis of Porous Gold for Nonenzymatic Electrochemical Detection of Glucose. Electrochem. Commun. 2007, 9 (5), 981-988.
35. Cherevko, S.; Xing, X.; Chung, C.-H. Hydrogen Template Assisted Electrodeposition of Sub-Micrometer Wires Composing Honeycomb-like Porous Pb Films. Appl. Surf. Sci. 2011, 257 (18), 8054-8061.
36. Yin, J.; Jia, J.; Zhu, L. Macroporous Pt Modified Glassy Carbon Electrode: Preparation and Electrocatalytic Activity for Methanol Oxidation. Int. J. Hydrogen Energy 2008, 33 (24), 7444-7447.
37. Zhuo, K.; Jeong, M.-G.; Chung, C.-H. Highly Porous Dendritic Ni-Sn Anodes for Lithium-Ion Batteries. J. Power Sources 2013, 244, 601-605.
38. Plowman, B. J.; Jones, L. A.; Bhargava, S. K. Building with Bubbles: The Formation of High Surface Area Honeycomb-like Films via Hydrogen Bubble Templated Electrodeposition. Chem. Commun. 2015, 51 (21), 4331-4346.
39. Li, Y.; Jia, W.-Z.; Song, Y.-Y.; Xia, X.-H. Superhydrophobicity of 3D Porous Copper Films Prepared Using the Hydrogen Bubble Dynamic Template. Chem. Mater. 2007, 19 (23), 5758-5764.
40. Gonzalez-Buch, C.; Herraiz-Cardona, I.; Ortega, E.; Garcia-Antón, J.; Perez-Herranz, V. Study of the Catalytic Activity of 3D Macroporous Ni and NiMo Cathodes for Hydrogen Production by Alkaline Water Electrolysis. J. Appl. Electrochem. 2016, 46 (7), 791-803.
41. Fan, M.; Garbarino, S.; Botton, G. A.; Tavares, A. C.; Guay, D. Selective Electroreduction of C02 to Formate on 3D [100] Pb Dendrites with Nanometer-Sized Needle-like Tips. J. Mater. Chem. A 2017, 5 (39), 20747-20756.
42. Ou, G.; Fan, P.; Zhang, H.; Huang, K.; Yang, C.; Yu, W.; Wei, H.; Zhong, M.; Wu, H.; Li, Y. Large-Scale Hierarchical Oxide Nanostructures for High-Performance Electrocatalytic Water Splitting. Nano Energy 2017, 35, 207-214.
43. Hyun Ahn, S.; Choi, I.; Park, H.-Y.; Jun Hwang, S.; Jong Yoo, S.; Cho, E.; Kim, H.-J.; Henkensmeier, D.; Woo Nam, S.; Kim, S.-K.; Jang, J. H. Effect of Morphology of Electrodeposited Ni Catalysts on the Behavior of Bubbles Generated during the Oxygen Evolution Reaction in Alkaline Water Electrolysis. Chem. Commun. 2013, 49 (81), 9323-9325.
44. Hazlett, R. D. Fractal Applications: Wettability and Contact Angle. J. Colloid Interface Sci. 1990, 137 (2), 527-533.
45. Shibuichi, S.; Onda, T.; Satoh, N.; Tsujii, K. Super Water-Repellent Surfaces Resulting from Fractal Structure. J. Phys. Chem. 1996, 100 (50), 19512-19517.
46. Synytska, A.; lonov, L.; Grundke, K.; Stamm, M. Wetting on Fractal Superhydrophobic Surfaces from “Core-Shell” Particles: A Comparison of Theory and Experiment. Langmuir 2009, 25 (5), 3132-3136.
47. Doyle, R. L.; Godwin, I. J.; Brandon, M. P.; Lyons, M. E. G. Redox and Electrochemical Water Splitting Catalytic Properties of Hydrated Metal Oxide Modified Electrodes. Phys. Chem. Chem. Phys. 2013, 15 (33), 13737-13783.
48. Zhang, C.; Qian, L.; Zhang, K.; Yuan, S.; Xiao, J.; Wang, S. Hierarchical Porous Ni/NiO Core-Shells with Superior Conductivity for Electrochemical Pseudo-Capacitors and Glucose Sensors. J. Mater. Chem. A 2015, 3 (19), 10519-10525.
49. Trotochaud, L.; Young, S. L.; Ranney, J. K.; Boettcher, S. W. Nickel-Iron Oxyhydroxide Oxygen-Evolution Electrocatalysts: The Role of Intentional and Incidental Iron Incorporation. J. Am. Chem. Soc. 2014, 136 (18), 6744-6753.
50. Bediako, D. K.; Lassalle-Kaiser, B.; Surendranath, Y.; Yano, J.; Yachandra, V. K.; Nocera, D. G. Structure-Activity Correlations in a Nickel-Borate Oxygen Evolution Catalyst. J. Am. Chem. Soc. 2012, 134 (15), 6801-6809.
51. Corrigan, D. A. The Catalysis of the Oxygen Evolution Reaction by Iron Impurities in Thin Film Nickel Oxide Electrodes. J. Electrochem. Soc. 1987, 134 (2), 377-384.
52. de Levie, R. In AdVances in Electrochemistry and Electrochemical Engineering; Delahay, P., Ed.; Interscience: New York, 1967; Vol. 6, p 329.
53. Mutha, H. K.; Lu, Y.; Stein, I. Y.; Cho, H. J.; Suss, M. E.; Laoui, T.; Thompson, C. V.; Wardle, B. L.; Wang, E. N. Porosimetry and Packing Morphology of Vertically Aligned Carbon Nanotube Arrays via Impedance Spectroscopy. Nanotechnology 2017, 28 (5), 05LT01.
54. Hao, M.; Garbarino, S.; Prabhudev, S.; Borsboom-Hanson, T.; Botton, G. A.; Harrington, D. A.; Guay, D. Vertically Aligned Ni Nanowires as a Platform for Kinetically Limited Water-Splitting Electrocatalysis. J. Phys. Chem. C 2019, 123 (2), 1082-1093.
55. Paasch, G.; Micka, K.; Gersdorf, P. Theory of the Electrochemical Impedance of Macrohomogeneous Porous Electrodes. Electrochim. Acta 1993, 38 (18), 2653-2662.
56. Candy, J.-P.; Fouilloux, P.; Keddam, M.; Takenouti, H. The Characterization of Porous Electrodes by Impedance Measurements. Electrochim. Acta 1981, 26 (8), 1029-1034.
57. Song, H.-K.; Jung, Y.-H.; Lee, K.-H.; Dao, L. H. Electrochemical Impedance Spectroscopy of Porous Electrodes: The Effect of Pore Size Distribution. Electrochim. Acta 1999, 44 (20), 3513-3519.
58. Musiani, M.; Orazem, M.; Tribollet, B.; Vivier, V. Impedance of Blocking Electrodes Having Parallel Cylindrical Pores with Distributed Radii. Electrochim. Acta 2011, 56 (23), 8014-8022.
59. Keiser, H.; Beccu, K. D.; Gutjahr, M. A. Abschstzung Der Porenstruktur Poröser Elektroden Aus Impedanzmessungen. Electrochim. Acta 1976, 21 (8), 539-543.
60. Gourbeyre, Y.; Tribollet, B.; Dagbert, C.; Hyspecka, L. A Physical Model for Anticorrosion Behavior of Duplex Coatings. J. Electrochem. Soc. 2006, 153 (5), B162-B168.
61. Itagaki, M.; Hatada, Y.; Shitanda, I.; Watanabe, K. Complex Impedance Spectra of Porous Electrode with Fractal Structure. Electrochim. Acta 2010, 55 (21), 6255-6262.
62. Nguyen, P. H.; Paasch, G. Transfer Matrix Method for the Electrochemical Impedance of Inhomogeneous Porous Electrodes and Membranes. J. Electroanal. Chem. 1999, 460 (1), 63-79.
63. McCrory, C. C. L.; Jung, S.; Peters, J. C.; Jaramillo, T. F. Benchmarking Heterogeneous Electrocatalysts for the Oxygen Evolution Reaction. J. Am. Chem. Soc. 2013, 135 (45), 16977-16987.
64. Guo, C. X.; Li, C. M. Room Temperature-Formed Iron-Doped Nickel Hydroxide on Nickel Foam as a 3D Electrode for Low Polarized and High-Current-Density Oxygen Evolution. Chem. Commun. 2018, 54 (26), 3262-3265.
65. Lu, X.; Zhao, C. Electrodeposition of Hierarchically Structured Three-Dimensional Nickel-Iron Electrodes for Efficient Oxygen Evolution at High Current Densities. Nat. Commun. 2015, 6, 6616.
66. Dong, G.; Fang, M.; Zhang, J.; Wei, R.; Shu, L.; Liang, X.; Yip, S.; Wang, F.; Guan, L.; Zheng, Z.; Ho, J. C. In Situ Formation of Highly Active Ni—Fe Based Oxygen-Evolving Electrocatalysts via Simple Reactive Dip-Coating. J. Mater. Chem. A 2017, 5 (22), 11009-11015.
67. Li, Y.; Yang, S.; Li, H.; Li, G.; Li, M.; Shen, L.; Yang, Z.; Zhou, A. Electrodeposited Ternary Iron-Cobalt-Nickel Catalyst on Nickel Foam for Efficient Water Electrolysis at High Current Density. Colloids Surf., A 2016, 506, 694-702.
68. Fritz, W. Berechnung des maximalen volumens von dampfblasen. Phys. Z. 1935, 36(11), 379-384. 1. °.

1. A method of fabrication of Ni electrodes by hydrogen bubbles dynamic templated electrodeposition of Ni on a substrate, the method comprising one of: i) selecting a current, and selecting an electrodeposition time at the selected current according to a deposit target thickness on the substrate; and ii) selecting an electrodeposition time, and selecting a current during the selected electrodeposition time according to the deposit target thickness on the substrate.

2. The method of claim 1, comprising selecting the current in a range between 2 A cm² and 10 A cm²; and selecting the electrodeposition time in a range between 10 s and 500 s.

3. The method of claim 1, comprising selecting the current in a range between 2 A cm² and 10 A cm²; and selecting the electrodeposition time in a range between 10 s and 450 s.

4. The method of claim 1, comprising selecting the electrodeposition time of 450 s, and selecting the current in a range between 2 A cm² and 10 A cm².

5. The method of claim 1, wherein the substrate is a Ni substrate, the target thickness is at least 35 μm, the method comprising setting the current at 2 A cm² and selecting the deposition time from at least 50 s until the deposit target thickness.

6. The method of claim 1, wherein the substrate is a Ni substrate, the deposit target thickness is at least 35 μm, the method comprising selecting setting the current at 2 A cm² and selecting the deposition time from at least 50 s, the method further comprising subsequent heat-treatment.

7. The method of claim 1, comprising subsequent heat-treatment.

8. The method of claim 1, wherein the substrate is a Ni substrate, the target deposit thickness is in a range between 35 μm and 220 μm, the method comprising selecting the current at 2 A cm² and selecting the deposition time in a range between 50 s and 450 s.

9. The method of claim 1, comprising selecting the current and selecting the electrodeposition time at the selected current according to the deposit on the substrate and according to target pore density and pore diameters on a surface of the deposit.

10. The method of claim 1, further comprising incorporating Fe onto structures of the deposit.

11. Hydrogen bubbles dynamic templated Ni film, comprising micrometer-sized pores at a surface thereof, and pore walls having a cauliflower-like secondary structure.

12. The film of claim 11, of a thicknesses in a range between 35 μm and 220 μm, a porosity in a range between 30 and 50%, and contact angles of at most 25°.

13. The films of claim 11, comprising pores of a diameter in a range between 10 and 30 μm at a surface thereof, and the pores wall of the cauliflower-like structure have pore diameters of at most 500 nm.

14. Hydrogen bubbles dynamic templated Ni electrode, wherein said electrode has a ratio between anodic (Qₐ) and cathodic (Q_{c}) coulombic charge of redox transition of a mean value of 1.00±0.13, and Qₐ values in a range between 62±4 mC cm⁻² and 539±57 mC cm⁻².

15. Electrode of claim 14, wherein a the ratio Qₐ/m is constant.

16. Dynamic hydrogen bubble templated Ni films, comprising a microporous primary structure and a highly porous cauliflower-like secondary structure, said films having stable OER overpotential down to η₂₅₀=310 mV at j=250 mA cm⁻²_{geometric} in 1M KOH electrolyte.

17. Dynamic hydrogen bubble templated Ni films of claim 16, said films having stable OER overpotential down to η₂₅₀=540 mV at j=250 mA cm⁻²_{geometric} in 1M KOH electrolyte.

18. Dynamic hydrogen bubble templated Ni films of claim 16, wherein said films have a Tafel slope (29 mV/decade) extending up to j=100 mA cm⁻²_{geometric}.

19. Dynamic hydrogen bubble templated Ni films of claim 16, wherein a contact angle between the surface and an air bubble is about 160°.

20. Dynamic hydrogen bubble templated Ni films of claim 16, wherein a contact angle between the surface and a water droplet is less than 25°.
